(19) United States
(12) Patent Application Publication
(10) Pub. No.: US 2008/0162188 A1
(43) Pub. Date: Jul. 3, 2008

(54) Method and system for generating graphical medication information

(76) Inventors: Sunil Kripalani, Conyers, GA (US); Dane Boyington, Hixson, TN (US); Sheila Boyington, Hixson, TN (US); Arun Mohan, Atlanta, GA (US); Robert Righter, Chattanooga, TN (US)

Correspondence Address: BRAKE HUGHES BELLERMANN LLP, c/o INTELLEVATE, P.O. BOX 52050, MINNEAPOLIS, MN, 55402, US

(21) Appl. No.: 11/811,778

(22) Filed: Jun. 12, 2007

Related U.S. Application Data
(60) Provisional application No. 60/812,609, filed on Jun. 12, 2006.

(51) Int. Cl. G06Q 50/00

(52) U.S. Cl. 705/3

(57) ABSTRACT

A system may include a prescription card manager configured to generate medication information cards. The prescription card manager may include a pharmacy database interface configured to receive notifications associated with medication prescriptions, each notification including identifications of a patient, a medication, and instructions associated with a specific medication prescription. A prescription decoder may obtain graphical medication representations based on the identification of the medication and graphical consumption representations based on the identification of instructions associated with the specific medication prescription. A card generator may be configured to generate a representation of a medication information card including one or more of the graphical medication representations and one or more of the graphical consumption representations based on the identification of the patient included in one or more of the notifications.

### CROSS REFERENCE TO RELATED APPLICATION

This application claims priority based on U.S. Provisional Application No. 60/812,609, filed on Jun. 12, 2006, entitled, “Method and System for Generating Graphical Medication Information,” the disclosure of which is hereby incorporated by reference.

### TECHNICAL FIELD

This description relates to pharmacy computing technologies.

### BACKGROUND

Prescription drug non-compliance has become a widespread problem. For example, recent studies have indicated that 8.7% of prescriptions may never be filled, almost 50% may be taken incorrectly, and adherence to long-term therapy may be, on average, less than half of what it ought to be, resulting in errors, medicines not working, and, ultimately, a reduction of therapeutic benefits for patients. This phenomenon may be referred to as non-compliance. Prescription drug non-compliance may have substantial health consequences for patients and financial consequences for payers, pharmacies, and manufacturers.

Experts believe that misunderstanding information related to how to take prescription drugs is a leading factor in both poor compliance and preventable adverse drug events. The ability to understand and act on health information may be referred to as health literacy. It is estimated that 90 million adult Americans may have a level of health literacy that negatively impacts their health care. The cost burden of low health literacy on the American health care system is substantial. One study found that 58.2% of patients at two hospitals did not understand directions to take a medication on an empty stomach. Other recent research has demonstrated that people with low health literacy skills may have difficulty distinguishing their medications from one another, and they may be less able to understand prescription drug warning labels. Such difficulties experienced by patients in understanding medication instructions, may thus result in inappropriate dosing, non-compliance, and inadequate control of medical conditions.

Large medical facilities may include pharmacies that service a large number of patients every day. Some pharmacies, for example, may have computerized systems configured to receive input from a pharmacy technician entering prescription information into the system and to send instructions to a robot or a screen so that the robot or a human may be instructed on obtaining the correct medication for packaging for the patient. The system may be automated to the extent that tubes may be used to physically transport the packaged medication to an access point for dispensing to the patient. A pharmacist may then receive the medication, verify that the received medication is correct, and counsel the patient on its use. There may be many patients waiting at any time to receive their medications, and thus pharmacists may not have time to prepare detailed instructions for each individual patient.

### SUMMARY

Therefore, in one aspect, a system is provided for generating medication information for patients in a format that provides for improved medication compliance, improved healthcare and lower costs.

According to one aspect, a system may include a prescription card manager configured to generate medication information cards. The prescription card manager may include a pharmacy database interface configured to receive notifications associated with medication prescriptions, wherein each one of the notifications includes an identification of a patient, an identification of a medication, and an identification of instructions associated with a specific medication prescription. The prescription card manager may include a prescription decoder configured to obtain graphical medication representations based on the identification of the medication and to obtain graphical consumption representations based on the identification of instructions associated with the specific medication prescription. The prescription card manager may further include a card generator configured to generate a representation of a medication information card including one or more of the graphical medication representations and one or more of the graphical consumption representations based on the identification of the patient included in one or more of the notifications.

According to another aspect, a computer readable medium may embody instructions stored thereon which, when executed by one or more processors, are configured to cause the one or more processors to perform receiving a first notification associated with a first medication prescription, wherein the first notification includes an identification of a first patient, an identification of a first medication, and an identification of instructions associated with the first medication prescription. The instructions may further cause the one or more processors to perform obtaining a first medication data item from a first database including information associated with the identification of the first medication that includes a first graphical medication representation of the first medication and obtaining a first graphical consumption representation of consumption instructions associated with the identification of instructions associated with the first medication. The instructions may further cause the one or more processors to perform generating a medication information card including the first graphical medication representation and the first graphical consumption representation based on the identification of the first patient.

According to another aspect, a method may include receiving a first notification associated with a first medication prescription, wherein the first notification includes an identification of a first patient, an identification of a first medication, and an identification of instructions associated with the first medication prescription. The method may further include obtaining a first medication data item from a first database including information associated with the identification of the first medication that includes a first graphical medication representation of the first medication. The method may further include obtaining a first graphical consumption representation of consumption instructions associated with the identification of instructions associated with the first medication. The method may further include generating a medication information card including the first graphical medication representation and the first graphical consumption representation based on the identification of the first patient.

According to another aspect, a method may include receiving an identification of a patient. The method may further include obtaining an identification of a medication and an identification of one or more instructions associated with the medication based on the identification of the patient. The method may further include obtaining a medication data item from a first database including information associated with the identification of the medication that includes a graphical medication representation of the medication. The method may further include obtaining a graphical consumption representation of consumption instructions associated with the identification of instructions associated with the medication. The method may further include generating a medication information card including the graphical medication representation and the graphical consumption representation based on the identification of the patient.

According to yet another aspect, a method may include receiving an identification of a medication and an identification of one or more instructions associated with the medication. The method may further include obtaining a medication data item from a first database including information associated with the identification of the medication that includes a graphical medication representation of the medication. The method may further include obtaining a graphical consumption representation of consumption instructions associated with the identification of instructions associated with the medication. The method may further include generating a medication information card including the graphical medication representation and the graphical consumption representation based on the identification of the medication and the identification of the instructions.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system for generating graphical medication information for patients.

FIG. 2 is a flowchart illustrating an example operation of the system of FIG. 1.

FIG. 3 is a flowchart illustrating an example operation of the system of FIG. 1.

FIG. 4 is a flowchart illustrating an example operation of the system of FIG. 1.

FIG. 5 illustrates an example table including example Sig codes indicating consumption instructions for medications.

FIGS. 6a-6d illustrate example formats of medication cards generated by an example system for generating medication information for patients.

FIG. 7 is an example screen shot illustrating an example format of a user interface associated with an example system for generating medication information for patients.

FIG. 8 is an example screen shot illustrating an example format of a user interface associated with an example system for generating medication information for patients.

FIG. 9 is an example screen shot illustrating an example format of a user interface depicting a lookup of a patient associated with an example system for generating medication information for patients.

FIG. 10 is an example screen shot illustrating an example format of a user interface depicting a selection of a patient associated with an example system for generating medication information for patients.

FIG. 11 is an example screen shot illustrating an example format of a user interface depicting an editing of information associated with a patient associated with an example system for generating medication information for patients.

FIG. 12 is an example screen shot illustrating an example format of a user interface depicting changes following an editing of information associated with the patient of FIG. 11.

FIG. 13 is an example screen shot illustrating an example format of a user interface depicting a request to add a new medication associated with the patient of FIG. 11.

FIG. 14 is an example screen shot illustrating an example format of a user interface depicting the request to add a new medication associated with the patient of FIG. 11.

FIG. 15 is an example screen shot illustrating an example format of a user interface depicting the patient information after the addition of the new medication associated with the patient of FIG. 14.

FIG. 16 depicts an example medication card jacket that may be generated to package an example medication card generated by the example system of FIG. 1.

FIG. 17 is an example screen shot illustrating an example format of a user interface depicting a lookup of a patient associated with an example system for generating medication information for patients.

FIG. 18 is an example screen shot illustrating an example format of a user interface depicting a selection of a patient associated with an example system for generating medication information for patients.

FIG. 19 is an example screen shot illustrating an example format of a user interface depicting an editing of information associated with a patient associated with an example system for generating medication information for patients.

FIG. 20 is an example screen shot illustrating an example format of a user interface depicting patient information after adding medications associated with a patient associated with an example system for generating medication information for patients.

FIG. 21 is an example screen shot illustrating an example format of a user interface depicting a modification to medication information associated with a patient associated with an example system for generating medication information for patients.

FIG. 22 is an example screen shot illustrating an example format of a user interface depicting a modification of information associated with a patient associated with an example system for generating medication information for patients.

FIG. 23 is an example screen shot illustrating an example format of a user interface depicting a modification of a information associated with a patient associated with an example system for generating medication information for patients.

FIG. 24 is an example screen shot illustrating an example format of a user interface depicting an addition of a patient associated with an example system for generating medication information for patients.

FIG. 25 is an example high level diagram of an example system for generating medication information for patients.

### DETAILED DESCRIPTION

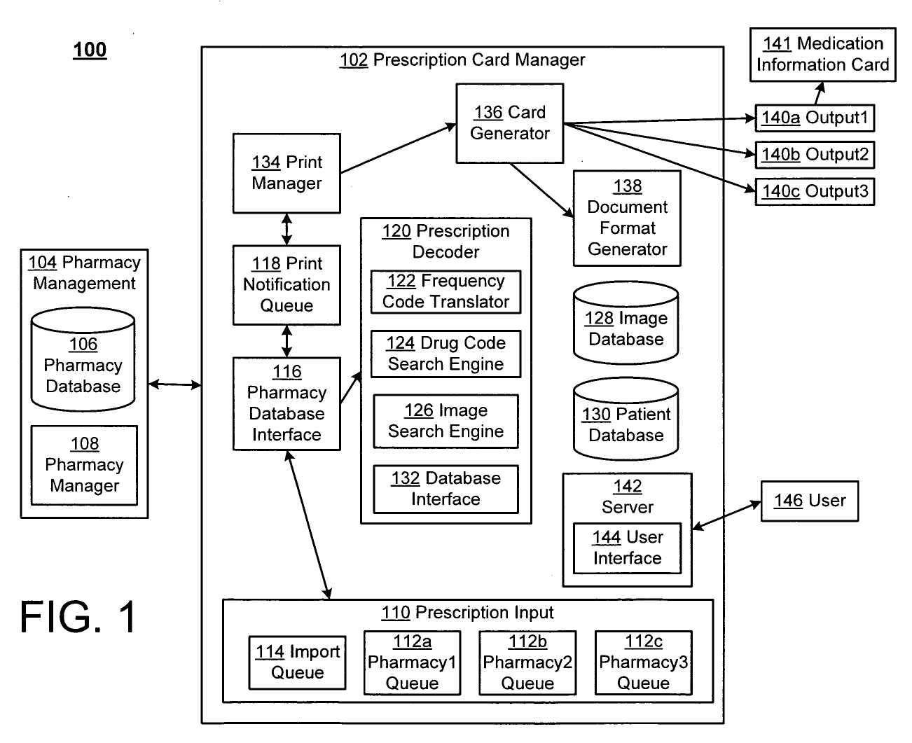

Referring to the Figures in which like numerals indicate like elements, FIG. 1 is a block diagram of a system 100 for generating graphical medication information for patients. In the example of FIG. 1, a prescription card manager 102 may be configured to generate medication information cards. The medication information cards may include, for example, cards printed on card stock, cards printed on paper, or cards generated to an electronic file format for portability by a patient. For example, an electronic file may be sent via email to a destination specified by a patient. The electronic file may be saved on an electronic medium and provided to the patient to be carried with the patient for viewing by viewing devices.

The medication information card may include personal patient information specific to the particular patient. For example, the medication information card may include the name and date of birth of the patient. The medication information card may include graphical representations of medications associated with current prescriptions of the patient, including, for example, pictures of the medications. The medication information card may include graphical representations of consumption or use instructions associated with the medications. For example, if a particular medication should be consumed or used in the morning and in the evening, the medication information card may include graphical representations of symbols associated with morning and evening, such as a sunrise and a sunset, or clock-like images displaying morning and evening hours. For example, if the particular medication is to be taken by mouth, the medication information card may include graphical representations of symbols associated with taking medication by mouth. For example, if the medication is to be applied to the surface of the skin, the medication information card may include graphical representations of symbols associated with applying medication to the skin. For example, for vision-impaired patients, the graphical representations may include sounds explaining the graphical symbols or symbols that may be felt such as Braille symbols explaining the graphical nature of the symbols.

According to an example embodiment, the medication may include medical supply items such as lancets or insulin syringes, and the medication information card may include graphical representations of symbols associated with the medical supplies and their recommended or prescribed usage. According to an example embodiment, the medication may include one or more of a medical supply item, a pill, a liquid, a gel, a paste, or an ointment.

The medication information card may include graphical purpose representations to indicate the purpose of the medications, including a graphical representation of a symptom for which the pill is prescribed, or another image associated with the purpose of the medication. For example, if the medication is prescribed to treat depression, then the medication information card may include a graphical representation of a sad face. For example, if the medication is prescribed to lower cholesterol levels, then the medication information card may include graphical representations of symbols associated with cholesterol, such as, for example, images of bacon and eggs.

The prescription card manager 102 may communicate with a pharmacy management system 104 which may include a pharmacy database 106 and a pharmacy manager 108. The pharmacy management system 104 may include processes and data that are proprietary to a particular pharmacy. The pharmacy database 106 may include data on patients for whom medications have been ordered from the pharmacy. It is to be understood, however, that the “pharmacy” may not be restricted to a physical traditional pharmacy location, but could also include any type of drug or drug information distribution system, such a mail-order drug distribution, electronic communication of prescription information to remote drug distribution locations or devices, etc.

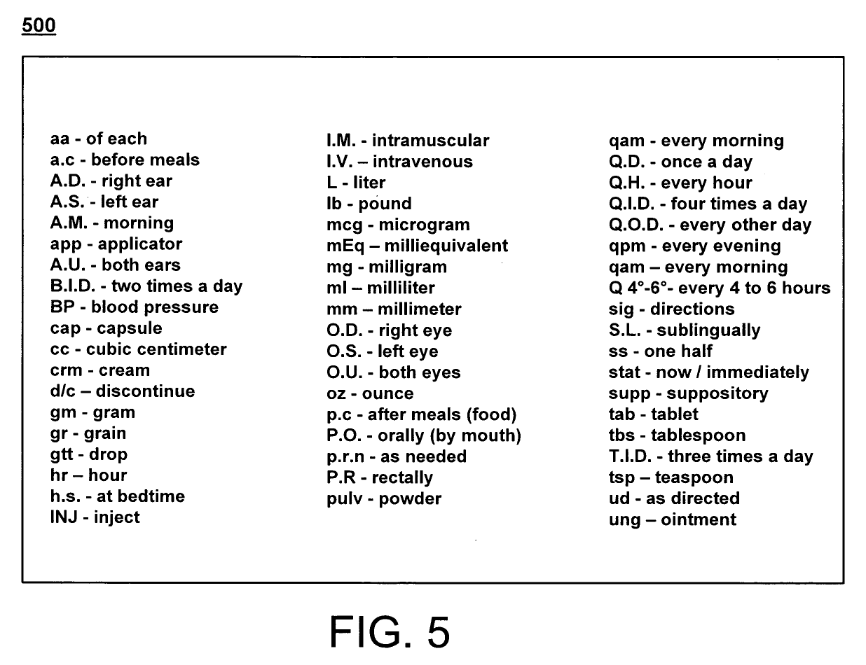

The data may include, for example, personal information associated with the patient, for example, the name and date of birth of the patient. The information may also include, for example, identifications of medications associated with prescriptions associated with a particular patient, as well as identifications of instructions associated with the prescriptions and the medications. For example, the pharmacy may store information regarding particular medications associated with, for example, proprietary codes that may be preferred by the pharmacy to identify the particular medications. The pharmacy may also store the information regarding particular medications associated with, for example, National Drug Codes (NDCs). The identifications of instructions associated with the prescriptions and the medications may be stored, for example, as Sig codes, as discussed below with regard to FIG. 5. For example, a Sig code of T.I.D. may be understood to mean to take the medication “three times a day.”

The pharmacy manager 108 may be configured to receive prescription orders from one or more pharmacies. The prescription orders may, for example, be entered via a user interface (not shown in FIG. 1), and information relating to the prescriptions may be entered by a pharmacist or pharmacy technician, for example, reading the prescription from a handwritten prescription sheet. The prescription orders may also be entered by physicians, or other appropriate personnel. The prescription orders may then be sent to various processing systems. For example, the prescription orders may be sent to a robot controller (not shown) to control a robot to retrieve the medication for dispensing to the patient. The prescription orders may also be sent, for example, to printing devices configured to print prescription labels to be attached to containers that contain the prescribed medications. It is possible that more than one prescription medication may be ordered for a particular patient in a single entry session. For example, the patient may need both an antibiotic and a painkiller.

After the patient has provided his/her prescription to be ordered, the patient may be directed to a waiting area to wait for the prescription to be filled and delivered to the patient.

The prescription card manager 102 may include a prescription input 110 storage device configured to store notifications associated with the prescription orders processed by the pharmacy manager 108. The prescription input 110 storage device may include pharmacy queues 112a, 112b, and 112c associated with 3 different pharmacies. The pharmacy queues 112a, 112b, and 112c may be configured to store the notifications associated with the prescription orders for each respective one of the 3 different pharmacies. An import queue 114 may be configured to store null information which the prescription card manager 102 may use in bootstrapping data for the system 100.

The prescription card manager 102 may include a pharmacy database interface 116 configured to receive the notifications associated with medication prescriptions, for example, from the prescription input 110 storage device or as requested by a user 146 via a user interface 144. Each one of the notifications may be associated with a prescription to be filled, and may include, for example, an identification of a patient, an identification of a medication, and an identification of instructions associated with a specific medication prescription. The identification of the patient may include, for example, an identification assigned to the patient by the pharmacy management system 104, or it may include, for example a unique identification such as a driver's license number or social security number. The pharmacy database interface 116 may be configured so that if information regarding the patient is not previously contained in a patient database 130, then the pharmacy database interface 116 may request such information from the pharmacy management system 104.

The identification of the medication may include, for example, an identification assigned to the medication by the pharmacy management system 104, or it may include, for example a unique identification such as a National Drug Code (NDC). The identification of instructions associated with a specific medication prescription may include, for example, Sig instructions as discussed further below.

The pharmacy database interface 116 may be configured to send card requests associated with each notification to a print notification queue 118. Each card request may include, for example, a timestamp associated with the notification. The card request may include the identification of the patient associated with the notification, and an indicator of a generated card destination. The timestamp may be used, for example, to determine a length of time since the notification was created. The indicator of the generated card destination may, for example, indicate a particular printer destination for printing of the medication information card associated with the prescription associated with the notification. The indicator of the generated card destination may, for example, indicate a particular electronic format destination of the medication information card, for example, a number of a cell phone or an email address.

The pharmacy database interface 116 may be configured to send each notification to a prescription decoder 120. The prescription decoder 120 may be configured, for example, to receive the notifications from the pharmacy database interface, and to obtain patient identifying information, from a pharmacy database, for example, the pharmacy database 106, based on the identification of the patient included in the notification. The prescription decoder 120 may be configured, for example, to determine a frequency of medication consumption based on the instructions associated with a specific medication prescription. For example, a frequency code translator 122 may be configured to determine the frequency of medication consumption, for example, by translating a Sig code, or a pharmacy management system 104 proprietary code, into times prescribed for taking the medication associated with the prescription.

Further, the prescription decoder 120 may be configured, for example, to determine a first drug code value based on the identification of the medication. For example, a drug code search engine may be configured to search, for example, for a National Drug Code (NDC) value associated with the identification of the medication. The search may include accessing the pharmacy database 106 to determine an appropriate NDC code for the identification of the medication included in the notification.

Additionally, the prescription decoder 120 may be configured, for example, to obtain one of the graphical medication representations from a first image database based on the identification of the medication. For example, an image search engine 126 may be configured to obtain the graphical medication representation from the first image database based on the identification of the medication. For example, the NDC value may be used to search an image database 128 for the image corresponding to the NDC value associated with the prescription.

The prescription decoder 120 may be configured, for example, to obtain one of the graphical consumption representations from a second image database based on the determined frequency of medication consumption. For example, the image search engine 126 may be configured to obtain the one of the graphical consumption representations from a second image database (not shown in FIG. 1) based on the determined frequency of medication consumption. For example, the images may include symbols associated with a time of day, e.g., a sunrise image and a sunset image. The images may alternatively include symbols indicating an exact time of day, for example, “8:00 a.m.” or “noon”, or may include “breakfast,” “lunch”, and/or “dinner.” The images may also include symbols associated with ways of administering or receiving the medication. For example, the images may include a symbol indicating a mouth to indicate the medication is to be taken orally. The images may also include a symbol indicating a measurement, for example symbols indicating two teaspoons, or symbols indicating three drops into an eye or ear from an eyedropper or eardropper. Alternatively, the information included in the image database 128 and the second image database may be included in a single database.

The prescription decoder 120 may be configured, for example, to store the first drug code value, the one of the graphical medication representations or, for example, an indicator associated with the one of the graphical medication representations (e.g., a suitable index or ID which identifies the representations in another database), and the one of the graphical consumption representations or an indicator associated with the one of the graphical consumption representations (e.g., a suitable index or ID which identifies the representations in another database) associated with the identification of the patient in a patient database 130. The patient database 130 may be configured, for example, to store prescription information associated with patients that are associated with the pharmacy, for example, patients having associated information stored in the pharmacy database 106. For example, a database interface 132 may be configured to store the drug code value, the graphical medication representation or indicator, and the graphical consumption representations or indicators associated with the identification of the patient in the patient database 130. For example, the information may be stored in the format of a row in a table including a patient identifier and the graphical representations or indicators.

The prescription decoder 120 may be configured, for example, to obtain a graphical purpose representation based on the identification of the medication and to store the graphical purpose representation or an indicator associated with the graphical purpose representation in the patient database. For example, the graphical purpose representation may include a symbol representing a symptom for which the medication is prescribed or another image associated with the purpose of the medication, for example, a symbol including pictures of a sad face for a symptom associated with depression, or a symbol representing a blood pressure monitor cuff for a device associated with high blood pressure.

Thus, for each notification processed by the pharmacy database interface 116, a card request associated with the notification may be sent to the print notification queue 118, and the notification may be sent to the prescription decoder 120. The drug codes, patient information, and graphical representations may then be obtained by the prescription decoder 120, and the graphical representations may be stored in the patient database 130, associated with the patient.

The prescription card manager 136 may include a print manager 134 that may be configured to monitor the print notification queue 118 to determine when each card request stored in the print notification queue 118 includes a timestamp older than a predetermined value. When the print manager 134 determines that a card request includes a timestamp satisfying the age constraint, the print manager 134 may obtain all call requests in the print notification queue 118 that are associated with a common identification of a patient, remove the respective call requests from the print notification queue 118, and send a request to a card generator 136 to generate a medication information card for the patient associated with the common identification of the patient. The request may include, for example, the identification of the patient and the indicator of the generated card destination. The indicator of the generated card destination may, for example, include an indicator of an output device associated with a particular area of the pharmacy that entered the prescription order into the pharmacy management system 104 for processing, for example, so that the medication information card may be output to a location near the associated patient's waiting area.

The predetermined value, or age constraint may be determined as an expiration value indicating a time that prescription requests may wait before a medication information card may be generated. Such an expiration value may allow enough time, for example five minutes, for a pharmacist or pharmacy technician to enter multiple prescriptions for the same patient before the medication information card is generated, so that all of the prescriptions may be included in one medication information card.

The card generator 136 may be configured to access the patient database 130 to obtain personal patient information and all current medication information including the graphical representations or indicators that are stored in the patient database 130, associated with the identification of the patient that is included in each card request. The patient database 130 may include information indicating an expiration date of prescriptions associated with each patient, and may include refill information associated with each prescription. Thus, the card generator 136 may be configured, for example, to obtain only the graphical representations that are associated with prescriptions that are not expired, or that have no refills left, and thus there is no medication available for the patient to take. The card generator 136 may, for example, be configured to obtain information regarding such expired or non-refilled prescriptions to generate a history of medications for the medication information card to provide information for the patient regarding medications previously prescribed for the patient.

The card generator 136 may be configured, for example, to generate a medication information card in a predetermined format based on the obtained personal patient information and all current medication information including the graphical representations or indicators that are stored in the patient database 130, associated with the identification of the patient that is included in each card request. For example, the medication information card may include the name and identification of the patient, the names of the medications that have been prescribed for the patient, and the graphical representations associated with each medication, for example, aligned in respective rows or columns for each medication. Alternatively, the graphical representations may be aligned according to times for taking the medications. For example, if three different pills need to be taken at breakfast time, the graphical representations of all three medications, along with the respective dosage graphical representations, may be grouped together with a graphical representation associated with breakfast time.

The card generator 136 may be configured, for example, to access a document format generator 138 to generate the medication information card according to a predetermined format, for example, according to a portable document format. As discussed previously, the medication information card may be generated according to an electronic format suitable for display on an electronic device.

The card generator 136 may be configured, for example, to determine a destination output device, for example, based on the indicator of the generated card destination included in the card request. For example, the card generator 136 may send the generated medication information card to be output at any one of output devices 140a, 140b, 140c, which may include output devices such as printers located, for example, at the pharmacy locations associated with the pharmacy queues 112a, 112b, 112c, respectively. For example, a medication information card 141 may be output as a printed card from the output device 140a.

After receiving the generated medication information card, a pharmacist or technician may review the medication information, and may determine that the information is incorrect or otherwise may need to be modified. Thus, a server 142, for example a web server, may include a user interface 144 that may be configured to interact with a user 146 to receive instructions from the user 146 for viewing, adding, deleting, and/or modifying the information regarding patients in the patient database 130. For example, the user interface 144 may be configured to display a graphical user interface (GUI) display on a viewing device such as a display screen so that the user 146 may request patient information, prescription information, and drug information, for example, stored in the patient database 130, and may add, delete, and/or modify such information to be stored in the patient database 130.

The user 146 may also initiate a request for a medication information card via the user interface 144, for example, by providing a patient identification. Such a request may, for example, be sent to the prescription input device 110 for processing as previously described. The user 146 may additionally add new drugs and/or graphical representations or images to the patient database 130. The user 146 may request a particular format for the medication information card, for example, a particular alignment of the card, or a particular electronic format of the card. The user 146 may, for example, request a particular language to be used for generating any text included in the medication information card. The user 146 may, for example, request a particular destination output device for a generated card, such as a telephone number or an email address or a particular printer.

According to another aspect, the user 146 may be located at a non-local location, and may interact with the server 142 via a web interface, for example, over the Internet or other network. The user 146 may be able to manually enter medication information associated with a patient manually, and may be able to print out the medication information card via a printer located locally to the user 146. For example, the card generator 136 may send an electronic format of the medication information card to the user 146 for printing or other types of display. As another example, the user 146 may also request that the medication information card be printed in a main processing office and be mailed to the patient if the user 146 does not have access, for example, to a color printer or other suitable output device.

According to another aspect, a physician may use a portable or handheld device, for example, a portable digital assistant (PDA) for tracking patient information. The handheld device may contain information regarding a medication regimen associated with a particular patient. The handheld device may then be configured to send the medication information associated with the patient to the prescription card manager 102, for example, via the user interface 144. As another example, the medication information associated with the patient may be sent to the prescription card manager 102, for example, via wireless exchange through a website or by synchronizing with a computer. A representation of the medication information card (e.g., a portable document file) may then be sent from the prescription card manager 102 to the handheld device for display on the handheld device, or for printing, for example, via an infrared port or local printing by a printer attached to a computer used for synchronization. Alternatively, a handheld device may be configured to receive information regarding a medication regimen associated with a particular patient that may be input manually by a user. The handheld device may be configured further to request a printout of the generated medication information card.

According to another aspect, the prescription card manager 102 may be configured to receive, for example, an identification of a patient from the user 146. The prescription card manager 102 may be configured further to obtain prescription information associated with the receive identification of the patient from the pharmacy database 106, and to generate the medication information card based on the obtained prescription information. In this aspect, the patient database 130 may be configured as a temporary storage area, for example, as a memory storage area or disk storage, for example, for maintaining data such as temporary used for generating the medication information card based on the prescription information obtained from the pharmacy database 106.

According to yet another aspect, the import queue 114 may include a null value so that a request may be sent to the import queue 114 and the pharmacy database interface 116 may, for example, be configured to process the request by requesting a dump of all patient identifications included in the pharmacy database 106 to be sent to the prescription decoder 120. The prescription decoder 120 may then obtain patient information for all patients included in the pharmacy database 106 so that the patient database 130 may be initially populated at startup.

The card generator 136 may be configured to generate a jacket that may include patient information, and may be configured to package the medication information card. The jacket may further be configured to package medication containers. The jacket may also include, for example, health awareness tips and/or advertising, for example health awareness tips and/or advertising for medications that may relate to a particular patient.

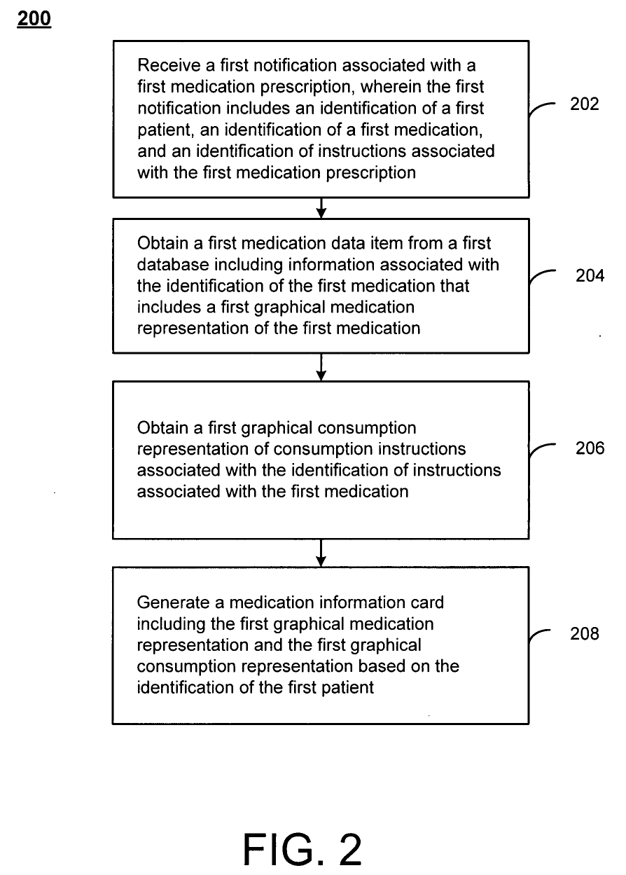

FIG. 2 is a flowchart 200 illustrating an operation of the system of FIG. 1. At 202, a first notification associated with a first medication prescription may be received. For example, the notification may be received from the pharmacy database interface 116 by the prescription decoder 120 as described previously. The notification, for example, may have been sent to the prescription input device 110 from a pharmacy as a result of a pharmacist or pharmacy technician entering information associated with a prescription into the pharmacy management system 104.

The first notification may include an identification of a first patient, an identification of a first medication, and an identification of instructions associated with the first medication prescription. For example, the identification of the first patient may include the identification of the patient included in the pharmacy database 106 as described previously. The identification of the first medication, for example, may include an identification of the first medication that may be maintained by the pharmacy database 106.

The identification of the instructions, for example, may include an identification of instructions for using the medication that may be maintained by the pharmacy database 106. At 204, a first medication data item may be obtained from a first database. The first medication data item may include information associated with the identification of the first medication that includes a first graphical medication representation of the first medication. For example, the first medication data item may be obtained by the image search engine 126 from the image database 128.

At 206, a first graphical consumption representation of consumption instructions associated with the identification of instructions associated with the first medication may be obtained. For example, the first graphical consumption representation of consumption instructions associated with the identification of instructions associated with the first medication may be obtained, for example, by the image search engine 126 from an image database that includes graphical consumption representations as described previously.

At 208, a medication information card including the first graphical medication representation and the first graphical consumption representation based on the identification of the first patient may be generated. For example, the medication information card may be generated by the card generator 136 as discussed previously.

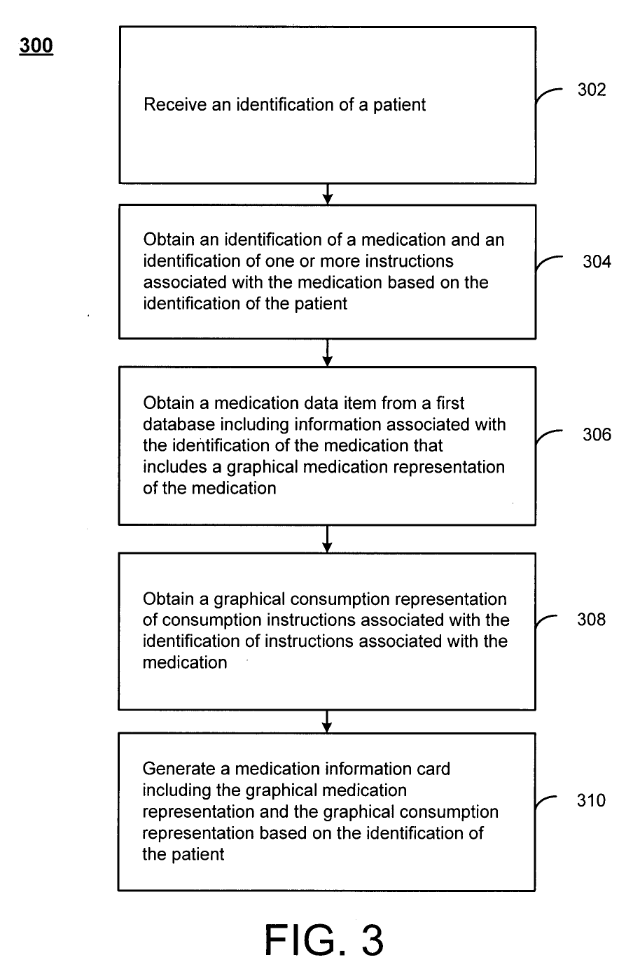

FIG. 3 is a flowchart 300 illustrating an operation of the system of FIG. 1. At 302, an identification of a patient may be received. For example, the identification of the patient may be received via the notification that may be received from the pharmacy database interface 116 by the prescription decoder 120 as discussed previously.

The identification of the instructions, for example, may include an identification of instructions for using the medication that may be maintained by the pharmacy database 106. At 304, an identification of a medication and an identification of one or more instructions associated with the medication may be obtained based on the identification of the patient. For example, the identification of the medication and the identification of one or more instructions associated with the medication may be included in the notification as discussed previously.

At 306, a medication data item may be obtained from a first database including information associated with the identification of the medication that includes a graphical medication representation of the medication. For example, the medication data item may be obtained by the image search engine 126 from the image database 128.

At 308, a graphical consumption representation of consumption instructions associated with the identification of instructions associated with the medication may be obtained. For example, the graphical consumption representation may be obtained by the image search engine 126 from an image database that includes graphical consumption representations as discussed previously.

At 310, a medication information card including the graphical medication representation and the graphical consumption representation may be generated based on the identification of the patient. For example, the medication information card may be generated by the card generator 136 as discussed previously. For example, the medication information card may be generated by the card generator 136 as discussed previously.

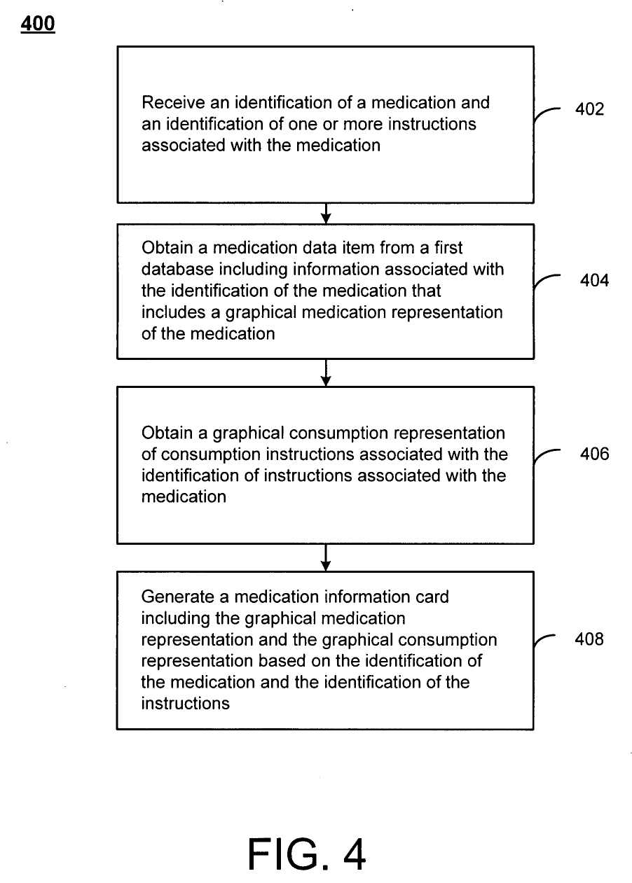

FIG. 4 is a flowchart 400 illustrating an operation of the system of FIG. 1. At 402, an identification of a medication and an identification of one or more instructions associated with the medication may be received. For example, the identification of the medication and the identification of one or more instructions may be received from a user such as the user 146 in contact with the user interface 144. For example, the user 146 may desire receiving a medication information card that includes information associated with medications, without providing specific patient information or specific information associated with a prescription.

As another example, the identification of the medication and the identification of one or more instructions may be received via the notification that may be received from the pharmacy database interface 116 by the prescription decoder 120 as discussed previously.

The identification of the medication, for example, may include an identification of the medication that may be maintained by the pharmacy database 106. The identification of the instructions, for example, may include an identification of instructions for using the medication that may be maintained by the pharmacy database 106.

At 404, a medication data item may be obtained from a first database including information associated with the identification of the medication that includes a graphical medication representation of the medication. For example, the medication data item may be obtained by the image search engine 126 from the image database 128.

At 406, a graphical consumption representation of consumption instructions associated with the identification of instructions associated with the medication may be obtained. For example, the graphical consumption representation of consumption instructions associated with the identification of instructions associated with the medication may be obtained, for example, by the image search engine 126 from an image database that includes graphical consumption representations as discussed previously.

At 408, a medication information card including the graphical medication representation and the graphical consumption representation may be generated based on the identification of the medication and the identification of the instructions. For example, the medication information card may be generated by the card generator 136 as discussed previously. As another example, the medication information card may be printed at a remote printer, for example, local to a user using a web browser via an Internet connection, or local to a remotely located kiosk.

FIG. 5 illustrates an example table 500 including example Sig codes indicating consumption instructions for medications. Such an example table may be used, for example, by the example drug code search engine 124 as discussed previously with regard to FIG. 1. For example, the example table 500 includes “T.I.D.” as a code indicating that a medication may be taken “three times a day.” Further, the example table 500 includes “BP” as a code indicating that a medication may be associated with “blood pressure.” Additionally, the example table 500 includes “P.O.” as a code indicating that a medication may be taken “orally (by mouth).” Thus, the example description decoder 120 described with regard to FIG. 1 may, for example, obtain graphical images associated with each of these Sig codes for inclusion in a medication information card. Further, the example card generator 136 may generate the medication information card formatted, for example, based on a Sig code indicating that a medication is to be taken “three times a day” by placing the graphical representation of the medication at three locations corresponding to the three times on the medication information card. As another example, the dosage to be taken at each time may be indicated (e.g., for 2 pills in the morning, an image of 2 pills may be shown, or an image of 1 pill may be shown with the number “2” indicating that 2 should be taken).

As another example, the medication information card may display times of day when the medication should be taken, thus, for example, helping low literacy patients to take their medication more reliably. As it has been customary for prescriptions and medications issued by pharmacies to indicate only the frequency of dosage (e.g. “take 1 pill 3 times a day”) instead of providing specific times (e.g., indicating that one pill should be taken in the morning, one pill in the afternoon, and one pill in the evening), the example system of FIG. 1 may include a system for recognizing and translating common prescription coding (e.g. “IT TID” or “1 pill 3 times a day”) into suggested times of the day for dosage.

For example, a graphical representation associated with taking a medication by mouth may be included in the medication information card if a Sig of “P.O.” is associated with the notification associated with a prescription. Also, a graphical representation associated with blood pressure may be included in the medication information card if a Sig of “BP” is associated with the medication.

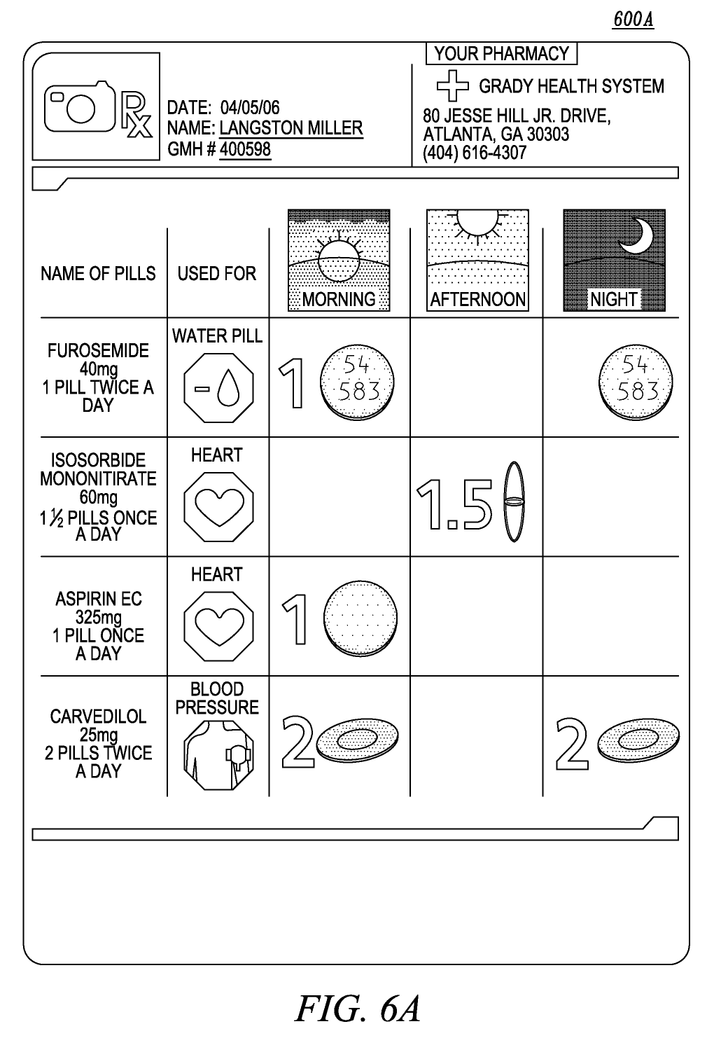

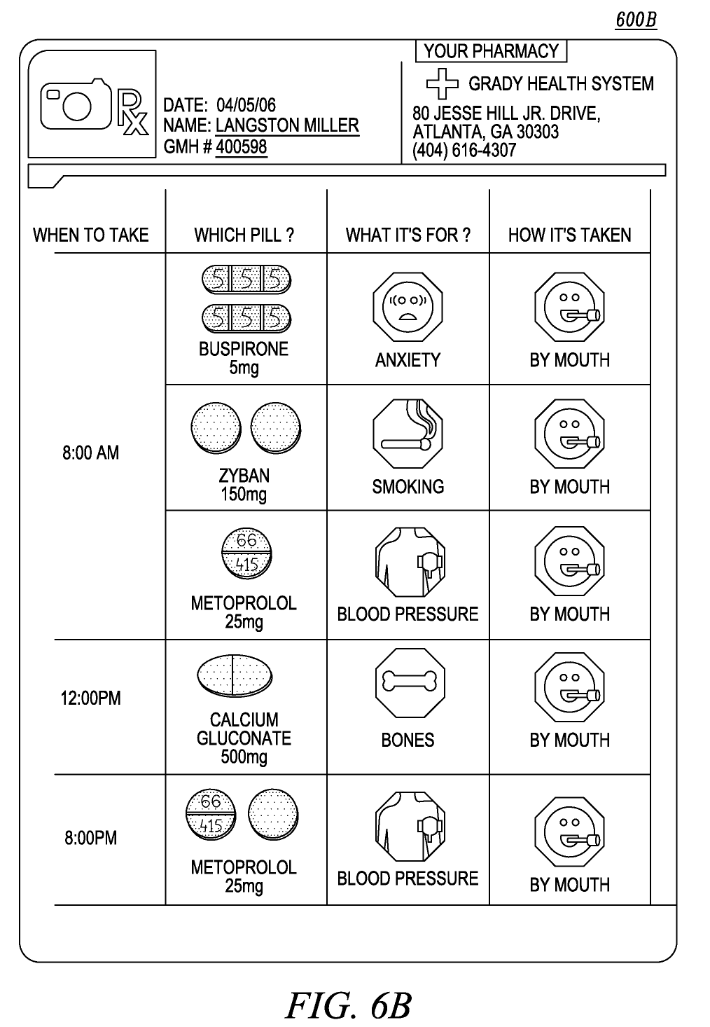

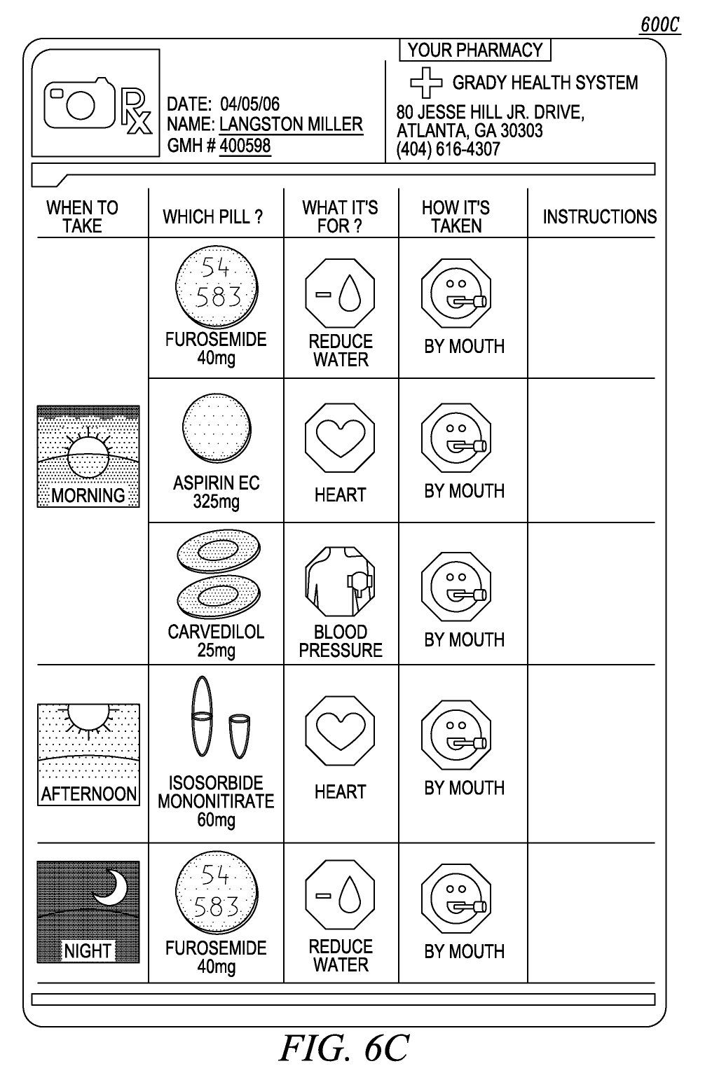

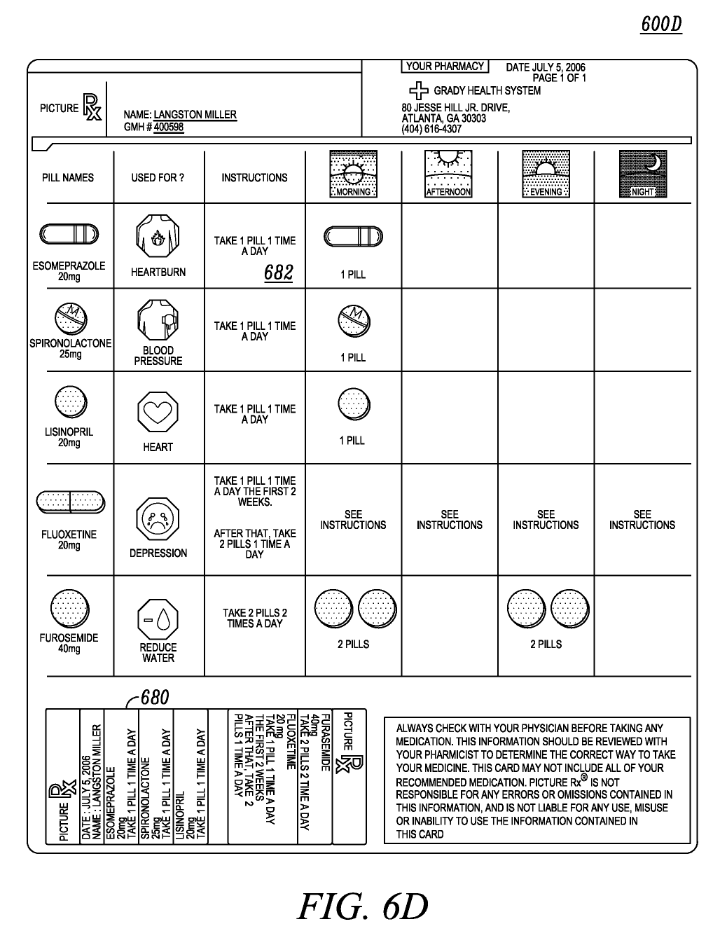

FIGS. 6a-6d illustrate example formats of medication cards generated by an example system for generating medication information for patients. For example, the format 600a illustrated in FIG. 6a includes example columns for times of day such that a patient may be able to simply locate the column corresponding to a particular time of day, for example, “morning” to look down the column to find pictures of all the medications to be taken or used at that time of day. In each row associated with each medication's image the patient may also see the corresponding name of the medication and “what it's for.” For example, the format 600a illustrated in FIG. 6a includes, for each medication symbol, a numeric symbol indicating, for example, the number of each pill to be taken at a particular time of day. For example, “1.5” pills of a particular pill may need to be taken in the “afternoon.”

As a further example, the format 600b illustrated in FIG. 6b may include, for each time of day, rows of example graphical symbols associated with the medications to be taken or used at that time of day. In the example of FIG. 6b, each example graphic symbol may be accompanied by an example text explanation associated with the symbol. In the example of FIG. 6b, the time of day may be indicated by numerals, e.g., “8:00 a.m.”

As a further example, the format 600c illustrated in FIG. 6c may include, for each time of day, rows of example graphical symbols associated with the medications to be taken or used at that time of day. In the example of FIG. 6c, each example graphical symbol may be accompanied by an example text explanation associated with the symbol. In the example of FIG. 6c, the time of day may be indicated by graphical symbols associated with the time of day. Special instructions may also be provided, for example, as a text explanation or as a pictorial image. For example, a text explanation may include a short dose taper explanation such as “3 pills a day for 5 days, then 2 pills a day for 5 days, then 1 pill a day for 5 days, then stop.”

As another example, the format 600d illustrated in FIG. 6d may include, for each time of day, a column of example graphical symbols associated with the medications to be taken or used at that time of day. In the example of FIG. 6d, the time of day may be indicated by graphical symbols associated with the time of day. Further, in the example of FIG. 6d, an example wallet-size punch out card 680 may be included in the medication information card so that the patient may carry the wallet-size card for quick reference on-the-go. Special instructions may also be provided, for example, as a text explanation or as a pictorial image. For example, a text explanation 682 may include an explanation such as “Take 1 pill 1 time a day.”

Thus, the medication information card, or graphic pill card, may help patients better understand indications for their medications, as well as how and when to take or use them. The medication information card as described herein may provide an illustration of a patient's medication regimen, with one example goal of improving patient understanding and compliance. The medication information card may include color images of each medication, including symbols which indicate its purpose (e.g., blood pressure cuff for antihypertensive) and time of administration (e.g., sunrise for morning). An electronic library of medication images and images of medical supplies, for example, may be based on a formulary of a health system, and may be compiled, for example, from online drug references, available image libraries, and actual digital pictures of medications and medical supplies. When patients receive the medication information card, it may, for example, be customized to their medication regimen, printed in color, and accompanied by a brief verbal explanation. Such a card may help patients better understand their medication regimen, and may clarify the purpose of each medication.

Impact on medication compliance and control of the patients' medical conditions, e.g., blood pressure, diabetes, cholesterol, etc., may be substantial. Such an impact on medication compliance may be of great clinical importance, since, as referenced above, studies have indicated that only 50-60% of patients may take their medications as prescribed. Additionally, graphic medication information cards may provide important added information for prescription packages. For example, many adults in the United States (up to 50% by some estimates) lack adequate functional literacy skills and may have difficulty understanding and applying written information. By providing a picture-based display of a patient's medication regimen, the graphic medication information card may be especially helpful for patients with limited literacy skills or poor language (e.g., English) proficiency.

Generating the medication information cards may include obtaining data on the medications including, for example, images of the medications. This information may, for example, be obtained from a different source than the prescription information.

Additionally, generating the medication information cards may include obtaining separate information associated with the medications, for example, including trade name, generic name, indications, etc. This information may, for example, be obtained from a separate source, or parts or all of this information may be obtained from previously described sources.

Generating the medication information cards may include filtering the data to determine the portions of the data that are of immediate interest, such as, for example, filtering the information for the patients for which the medication information cards are desired.

Generating the medication information cards may, for example, include cross-referencing or collating the data into a separate, new database that stores information needed to produce the medication information card. This cross-referencing may be done on the basis of unique identifying information, such as patient identification numbers and/or drug identification numbers such as the National Drug Code (NDC) value.

Since the prescription data may not be available in such a way that data for all prescriptions are available at one time, but instead prescription data may be available only for individual prescription medications, i.e., as prescriptions are filled, then an example system or method for generating the medication information card may retain a running record of past prescriptions for each patient so that the medication information card may include a record of all current medications being taken by the patient.

Optionally, an example system or method for generating the medication information card may determine from the prescription records when certain prescriptions are due to expire, so that the expired prescriptions may not be included in future medication information cards generated for that patient.

An example system or method for generating the medication information card may monitor data produced by an existing computer system in the pharmacy to detect when a patient has come to the pharmacy for a new or refill prescription. In one aspect, an example system may automatically create, format and print on a printer a medication information card from the data which has been discovered by the system, so that the medication information card may be automatically available to the pharmacist when the prescription is filled or dispensed to the patient.

In another example aspect, the medication information card may be generated on demand when a pharmacist or other technician inputs a request for a medication information card. According to an example embodiment, a pharmacist or technician may have the ability to retrieve and edit the information about a patient's medication regime on a computer screen. According to an example embodiment, an example system or method for generating the medication information card may include a means for a pharmacist or technician to input and/or edit a list of the patients for which the system records or monitors data and generates medication information cards. Thus, for example, a pharmacist or other user may enter all of the information on a patient manually, including the patient's identifying information, without relying on an automatic extraction of patient information from the pharmacy computers. This technique may be used, for example, when a patient may be new to the pharmacy and there are therefore no existing records, or, for example, when the system is otherwise not functioning.

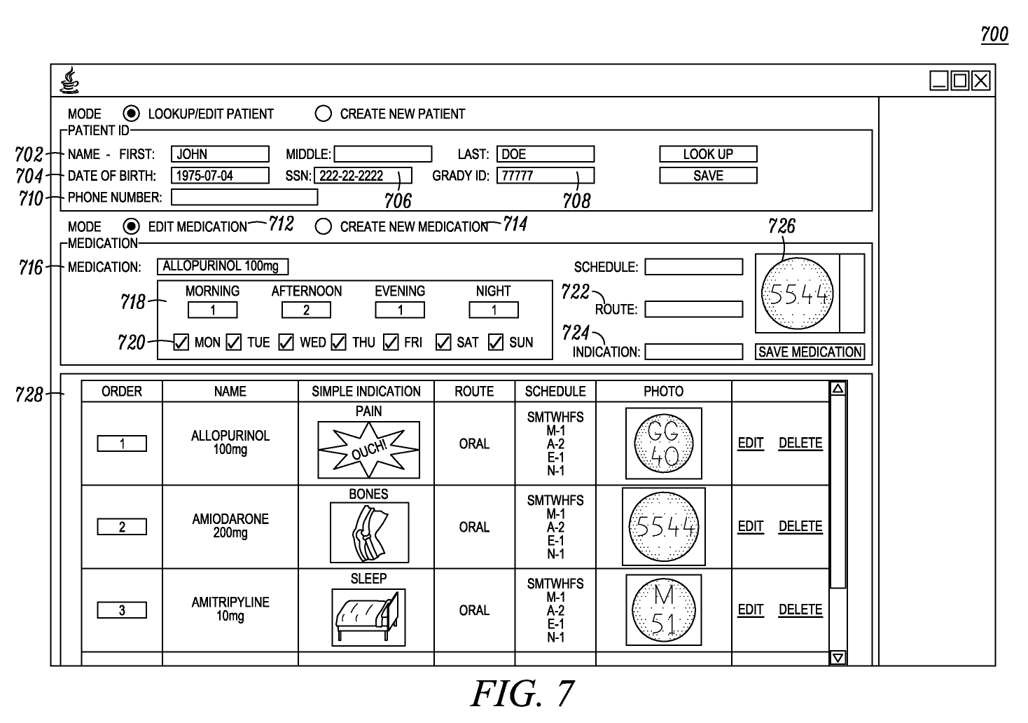

For example, FIG. 7 is an example screen shot 700 illustrating an example format of a user interface associated with an example system for generating medication information for patients. As shown in FIG. 7, the example, screen display 700 may include example fields for personal patient information such as name 702, date of birth 704, social security number 706, the patient identification number 708 associated with the pharmacy, and telephone number 710. The example screen display 700 may include selector modes for editing medications 712 or creating new medications 714 for a particular patient. The example screen display 700 may include example fields indicating the names of medications 716, as well as selector fields for times of day 718 and days of the week 720 for the patient to take the medication. The example screen display 700 may include selector fields for “route” 722 (e.g., “by mouth”) and “indication” 724 (e.g., “high cholesterol”). A graphical representation of the medication 726 may be displayed while the user edits the fields on the screen 700.

An example graphical display of the current information available 728 for a patient's medical information card may be displayed as the user edits the fields on the screen 700. As shown in FIG. 7, the information associated with each prescribed medication may be edited or deleted by the user. Additionally, for a search or lookup, choices may be displayed via graphical representations.

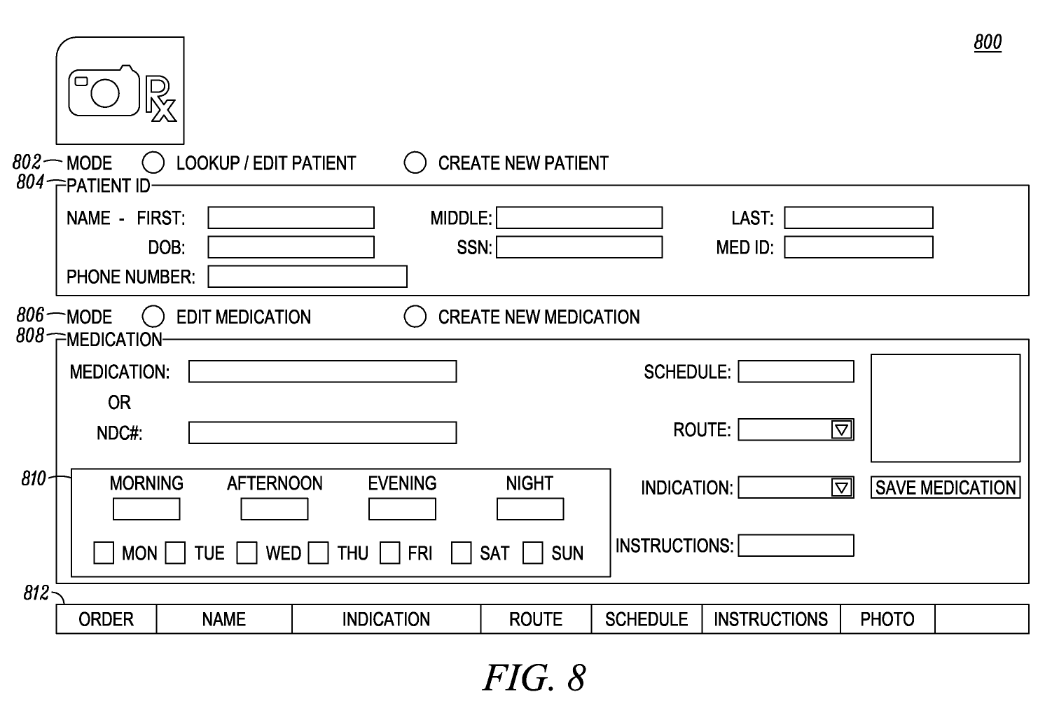

FIG. 8 is an example screen shot 800 illustrating another example format of a user interface associated with an example system for generating medication information for patients. The user interface may include, for example, the user interface 144 of FIG. 1 described previously. An example pharmacist/user input screen is illustrated in FIG. 8 without any data. Using such a user interface, a user such as the user 146 of FIG. 1 may add new patients or recall existing patients, for example, associated with the patient database 130 of FIG. 1.

FIGS. 8-15 each include example blocks patient mode 802, patient ID 804, medication mode 806, medication information 808, time of day 810, and medication display information 812. The example block patient mode 802 may include a lookup/edit patient field and a create new patient field for selecting a mode of editing patient information included in the example block patient ID 804. The example block patient ID 804 may include name fields for first, middle, and last names of a patient, a date of birth field, and SSN field for a patient's social security number, a Med ID field for a patient's identification number within an organization, and a patient phone number field. The example block medication mode 806 may include an edit medication field and a create new medication field for selecting a mode of editing medication information included in the example block medication information 808.

The example block medication information 808 may include a medication name field, an NDC# field for a National Drug Code associated with a medication, a schedule field, a route field, an indication field, and an instructions field for patient instructions regarding the medication. The example block medication information 808 may also include a save medication button which may be selected when information has been entered in the block medication information 808. The example block time of day 810 may include fields for morning, afternoon, evening, and night, and fields for each day of the week. Thus, the block time of day 810 may be used to indicate what day of the week, and what times of the day a medication may be taken or used by a patient. The example block medication display information 812 may include fields for listing order, medication name, indication, route, schedule, instructions, and photo for indicating information to be displayed in display blocks to show current choices in the example blocks patient mode 802, patient ID 804, medication mode 806, medication information 808, time of day 810, as discussed further below. One skilled in the art of data processing that many other types of example blocks and fields may be used for patient and medication information.

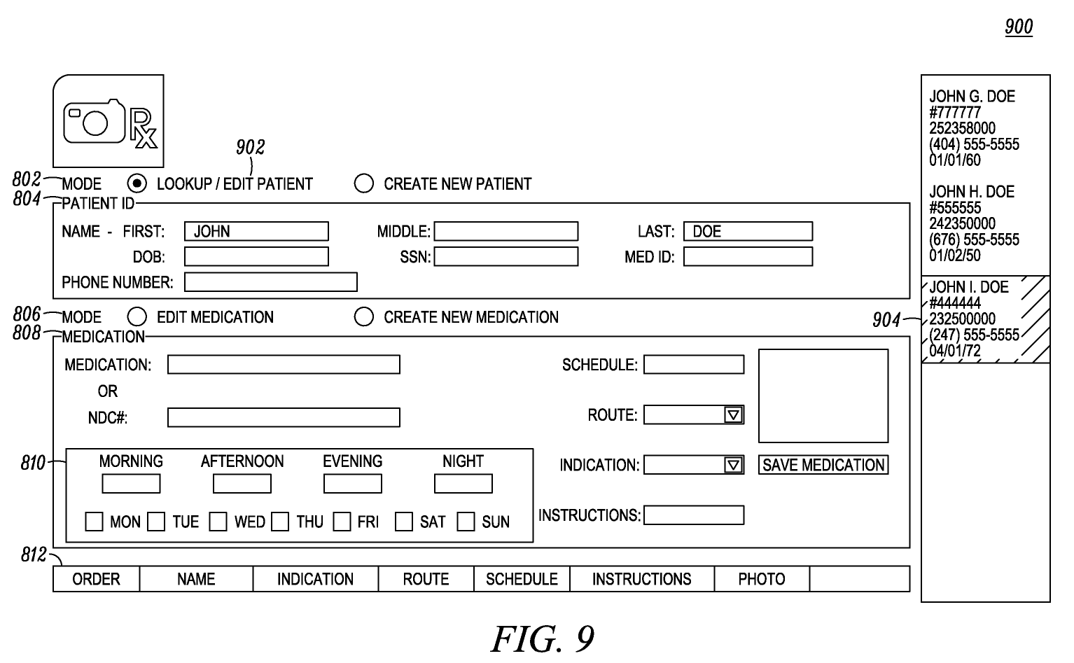

FIG. 9 is an example screen shot 900 illustrating an example format of a user interface depicting a lookup of a patient associated with an example system for generating medication information for patients. In the example of FIG. 9, an example user, such as, for example, the user 146, may select patients by entering a unique identifier or typing other information. The example user may select from several options that match information that is entered via the user interface. As shown in FIG. 9, the example user has selected “lookup/edit patient” 902 and thus an example list of patients may be displayed for selecting a particular patient named “John Doe” 904 from a list of several “John Doe” names.

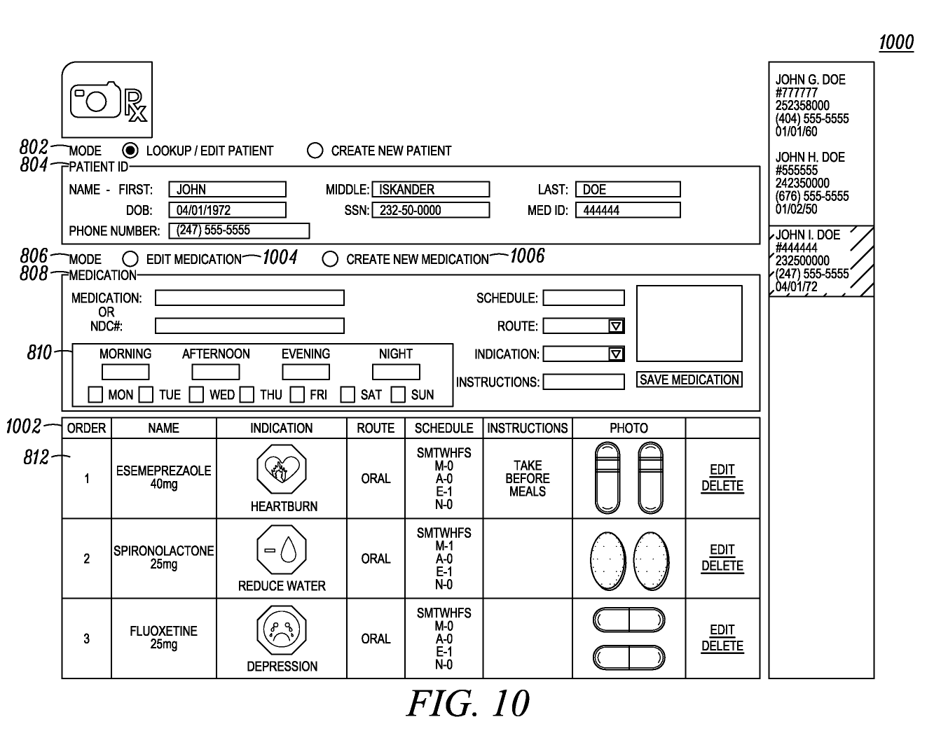

FIG. 10 is an example screen shot 1000 illustrating an example format of a user interface depicting a selection of a patient associated with an example system for generating medication information for patients. Once a patient has been selected as described with regard to FIG. 9, current medications associated with the selected patient may be displayed 1002. This information may be obtained, for example, from the patient database 130 via the user interface 144. The example user may, for example, edit medications 1004 or add new medications 1006 associated with the example selected patient.

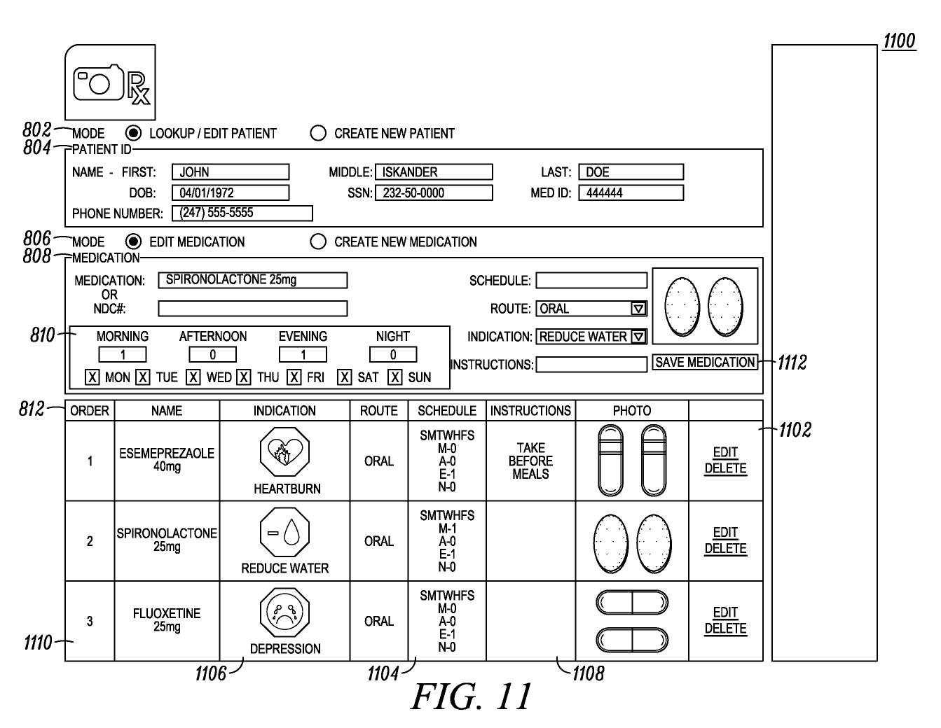

FIG. 11 is an example screen shot 1100 illustrating an example format of a user interface depicting an editing of information associated with a patient associated with an example system for generating medication information for patients, according to an example embodiment. The example user may be able to edit a single medication, for example, by clicking “Edit” 1102. By doing so, the example user may, for example, change the schedule 1104, indication 1106, instructions 1108, or order 1110 in which a particular medication may appear on the medication information card. The example users may record changes, for example, by clicking “Save Medication” 1112.

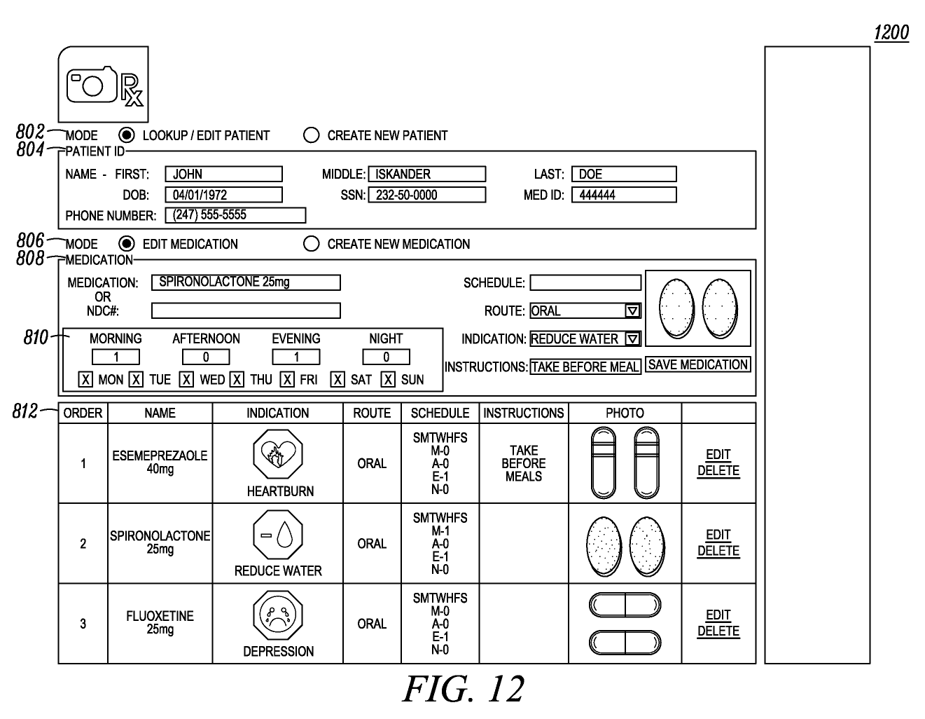

FIG. 12 is an example screen shot 1200 illustrating an example format of a user interface depicting changes following an editing of information associated with the patient of FIG. 11. In the example of FIG. 12, the example user has edited a medication by changing a schedule, as reflected in the example list of medications displayed by the example display 1200.

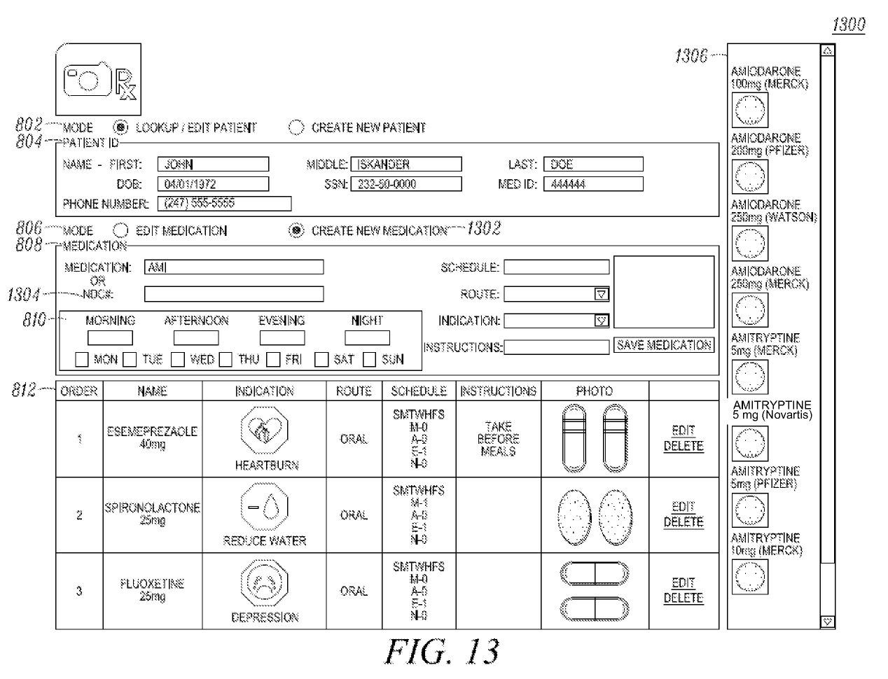

FIG. 13 is an example screen shot 1300 illustrating an example format of a user interface depicting a request to add a new medication associated with the patient of FIG. 11. As shown, the example user may switch to “Create New Medication” mode 1302 to add a new medication. The example user may then enter a unique identifier 1304 (e.g., NDC number) or type the name of the medicine. Once the example user begins to type, example medications 1306 which match the information that is entered may be displayed, for example, on the right. The example user may then select the appropriate medication from the displayed choices 1306.

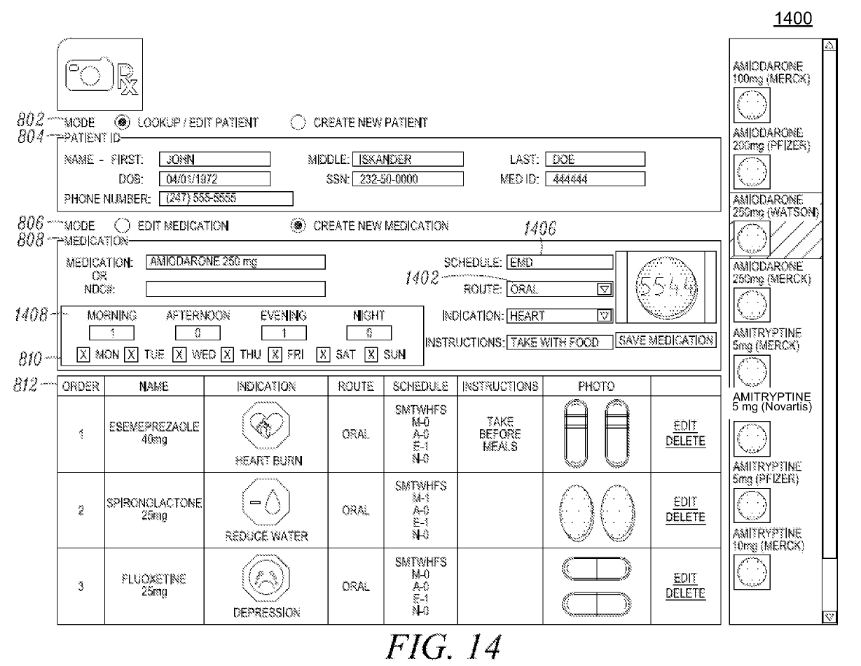

FIG. 14 is an example screen shot 1400 illustrating an example format of a user interface depicting the request to add a new medication associated with the patient of FIG. 13. An example user may select appropriate items corresponding to the new medication. Some information, such as route 1402, may appear automatically. Other information, such as schedule 1406, may, for example, need to be selected. The example user may either enter “BID” (e.g., a Sig code) for twice a day or may enter the information in a detailed table 1408. The example table 1408 shown in FIG. 14 may allow the user to customize exactly which days the medication is to be taken.

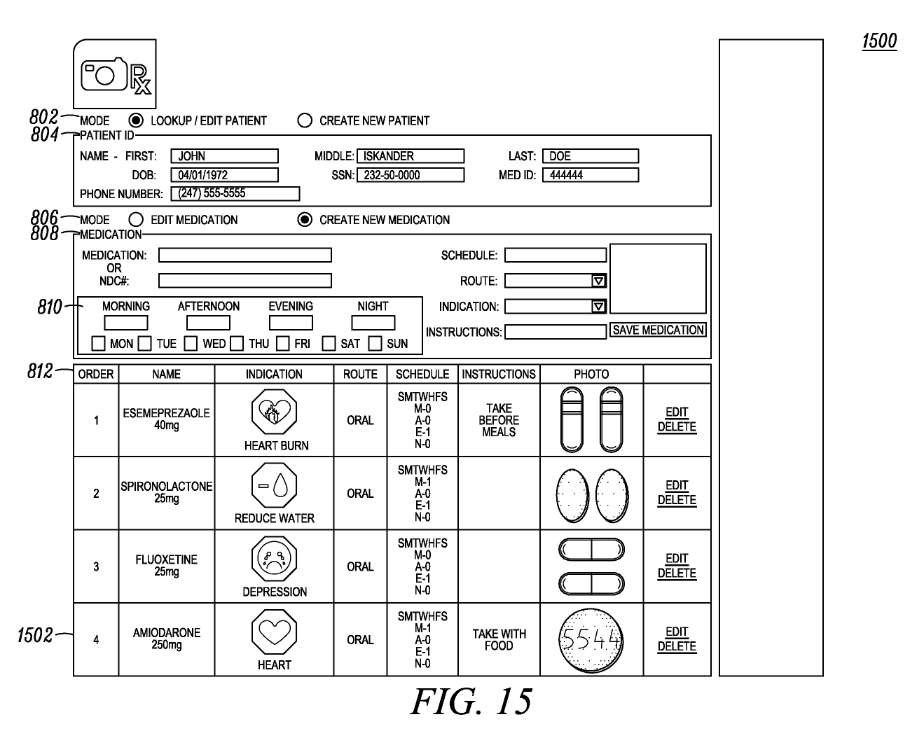

FIG. 15 is an example screen shot 1500 illustrating an example format of a user interface depicting the patient information after the addition of the new medication 1502 associated with the patient of FIG. 14. As shown in FIG. 15, once medication has been saved it may appear on the bottom of the current medications displayed on the display 1500.

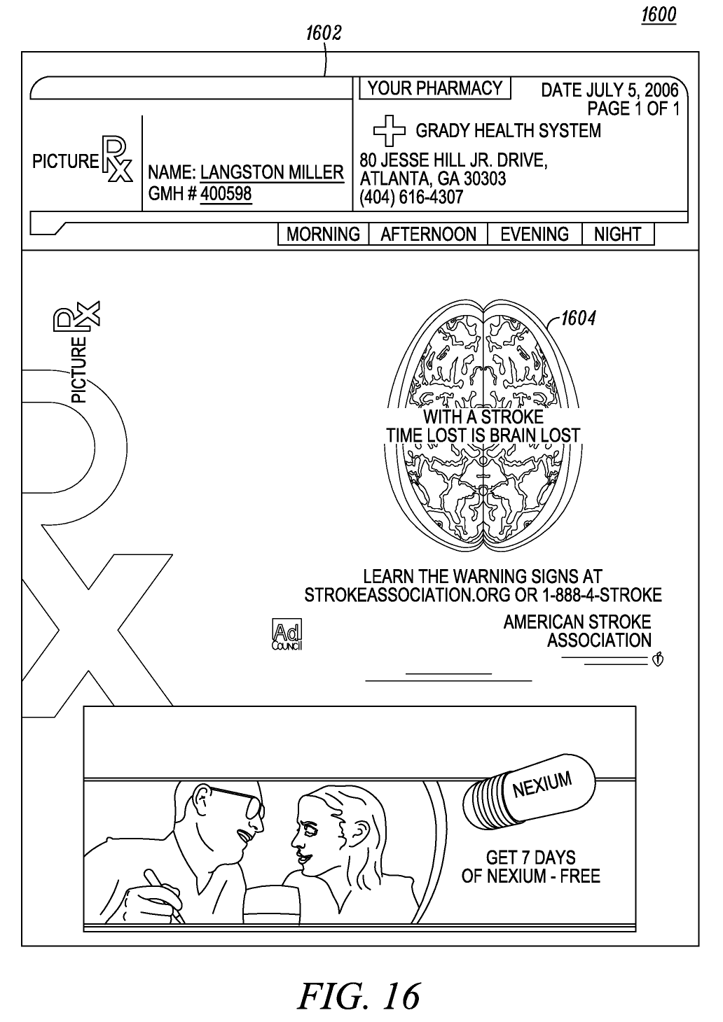

FIG. 16 depicts an example medication card jacket 1600 that may be generated to package an example medication card 1602 generated by the example system of FIG. 1. As shown, the example medication card jacket may be configured to package the patient's medications and/or the medication information card to be dispensed simultaneously for the convenience of the pharmacist and the patient. As shown, the example jacket may include advertising 1604 and/or coupons, for example, advertising and/or coupons of medication developers and manufacturers.

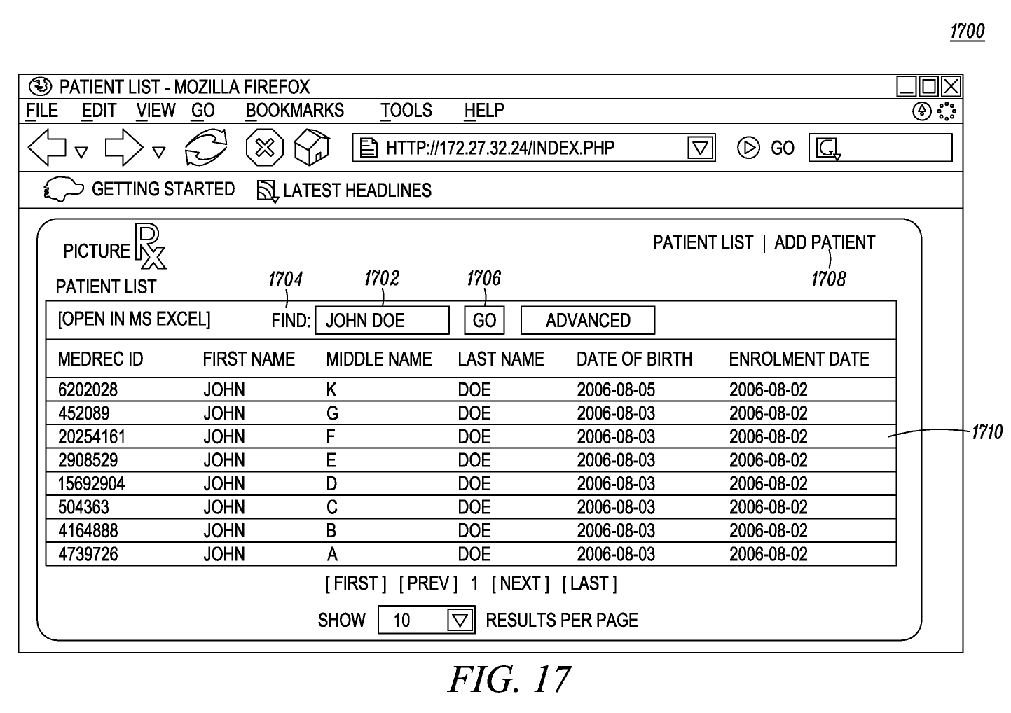

According to another example embodiment, FIG. 17 is an example screen shot 1700 illustrating an example format of a user interface depicting a lookup of a patient associated with an example system for generating medication information for patients. In the example of FIG. 17, an example user, such as, for example, the user 146, may search for a patient by typing either a patient's identifying number or name 1702 in a field 1704 marked “find” and selecting a field 1706 marked “go.” As shown in FIG. 17, the user has searched for a patient named “John Doe.” As shown in the example of FIG. 17, names of patients matching the search criteria appear in a display area 1710 included in the screen shot 1700.

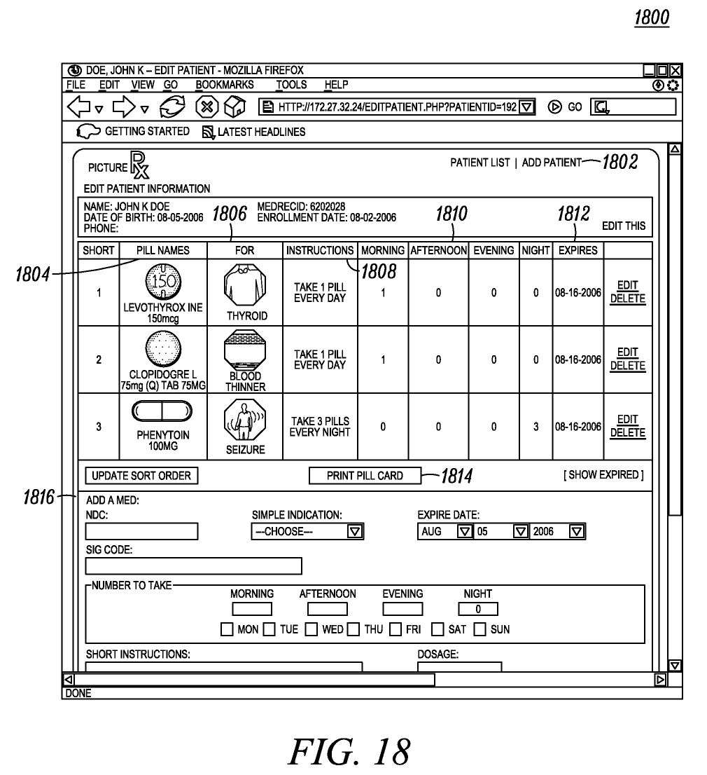

According to another example embodiment, FIG. 18 is an example screen shot 1800 illustrating an example format of a user interface depicting a selection of a patient associated with an example system for generating medication information for patients. Once a patient has been selected as described with regard to FIG. 17, current medications associated with the selected patient may be displayed. This information may be obtained, for example, from the patient database 130 via the user interface 144. The example user may, for example, edit medications or add new medications associated with the example selected patient. As shown in FIG. 18, several types of patient information may be edited. Examples of patient information may include pill or medication names 1804, which may include a generic name and dosage as well as an image of the pill or medication. Further, the patient information may include a “used for” indicator 1806, which may provide a description of indications associated with each pill or medication. An example list of indications is shown below in Table I.

TABLE I
(Indications)

| | |
|---|---|
| ADHD | Hormones |
| Adds Moisture | Infection |
| Allergies | Kidney |
| Anemia | Medical Supplies |
| Antidote | Memory |
| Anxiety | Multiple Sclerosis |
| Arthritis | Myasthenia Gravis |
| Birth Control | Muscle Spasm or Cramp |
| Bleeding | Urine Control |
| Lower Blood Pressure | Upset Stomach |
| Blood Thinner | Pain |
| Bones | Parkinson's |
| Breathing | Psoriasis |
| Cancer | Prostate |
| Cholesterol | Rash |
| Constipation | Extra Salt |
| Crohn's Disease or | Control Thoughts or Behaviors |
| Ulcerative Colitis | Seizure |
| Cough | Sleep |
| Depression | Smoking |
| Diabetes | Swelling or Redness |
| Diarrhea | Thyroid |
| Dizziness | Transplant |
| Fever | Vaccine |
| Glaucoma | Reduce Water |
| Gout | Weight Loss |
| Headache | Wounds or Burns |
| Heart | Nutrition |
| Heartburn or Ulcer | |

Further, the patient information may include instructions 1808, which may include a text description of how meds should be taken. Additionally, the patient information may include a schedule 1810, which may, for example, indicate when each medicine should be taken. For example, a number in each column may indicate a number of pills to be taken at that time. According to an example embodiment, when printing, these numbers may be replaced by pill images as well as numbers.

Additionally, the patient information may include an “expires” indicator 1812 which may, for example, indicate when the patient will no longer have medications (e.g., when taken properly) or when the patient should stop taking the medications.

According to an example embodiment, a user may review the patient's information, as shown in FIG. 18, and then preview the medication information card and print, for example, by selecting “Print Pill Card” 1814 as shown below the patient information in FIG. 18. After previewing the medication information card, the user may request, for example, that the medication information card be sent to a printer.

According to an example embodiment, medications may be added for a patient by adding information to a medication add area 1816, as discussed further below.

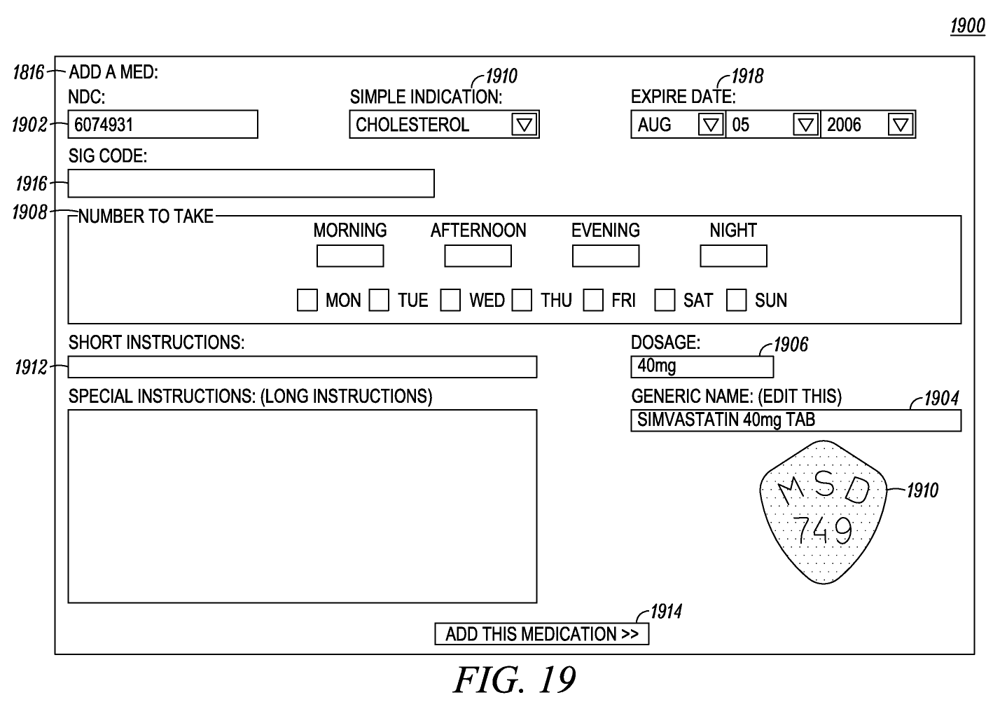

According to another example embodiment, FIG. 19 is an example screen shot 1900 illustrating an example format of a user interface depicting an editing of information associated with a patient associated with an example system for generating medication information for patients. The example user may be able to edit a single medication, for example, by filling in information shown in the area labeled “Add a Med” 1816. For example, an NDC number may be entered in an area labeled “NDC” 1902. The generic name 1904, tablet size 1906, and usage 1806 of the drug may appear automatically as in FIG. 18. An example user may then, for example, change the schedule 1908, indication 1910, instructions 1912, or order in which a particular medication may appear on the medication information card. The example users may record changes, for example, by clicking “Add This Medication” 1914.

After a user has reviewed a patient's information, the user may preview and print a pill card or medication information card. In order to print the pill card, the user may select “Print Pill Card” 1814 just below the patient information.

In order to add medications, a user may open up the patient's information as shown below in FIG. 18 and scroll down to an area that indicates “Add a Med” 1816. For example, a user may add Simvastatin 40 mg PO.

The user may enter an NDC number in the area 1902 that indicates “NDC.” Once the NDC is entered, the user may, for example, press a Tab key, and the generic name 1904, tablet size 1906, and what the drug is used for 1806 may fill automatically as shown in FIG. 19. The user may change the indication by clicking on the pull-down menu 1910.

Once the proper medication has been entered the user may use the Sig code 1916 to describe how often the medication should be taken. Users can take advantage of a variety of shortcuts such as IT PO QD as shown below. By pressing a Tab key, a box 1908 labeled “Number to Take” may automatically populate. The “Number to Take” box 1908 shows the number of pills that should be taken in the morning, afternoon, evening and night. For this example, the user will edit the information for the patient to take 1 pill each day in the morning. Information in the box 1908 may be edited and may takes precedence over the Sig code entry 1916. An example default scenario may include a medication being prescribed for each day of the week, which may be changed, for example, by only selecting the days of a week the medication should be taken. The pharmacist may also specify an expire date 1918 when the patient should either stop taking the medicines or will run out. The user may use a “Short Instructions” field 1912 may be used to describe when the patient should take each med. This information may appear in a column adjacent to a “Used For” column in a pill card.

After a user has finished adding all medication information, the user may select “Add This Medication” 1914.

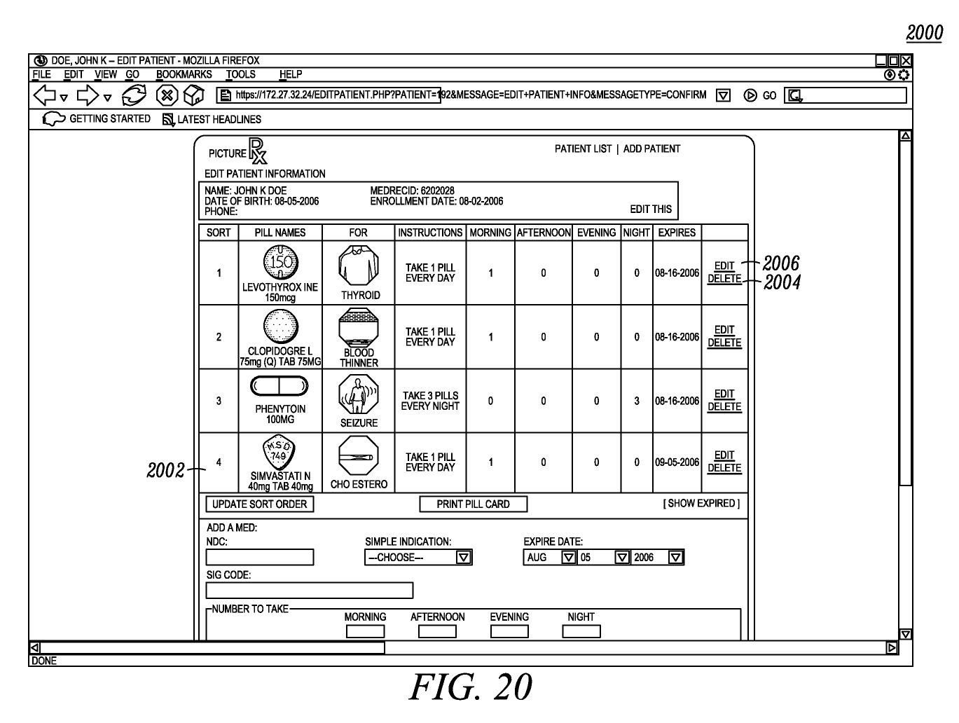

According to another example embodiment, FIG. 20 is an example screen shot 2000 illustrating an example format of a user interface depicting patient information after adding medications associated with a patient associated with an example system for generating medication information for patients. In the example of FIG. 20, a display shows that Simvastatin 2002 has been added to the medications associated with the patient John Doe.

If a user desires to delete a medication from a patient's record, the user may select delete 2004 next to the medication to be deleted. Similarly, if the user desires to edit a medication included in a patient's record, the user may select edit 2006 next to the medication to be edited.

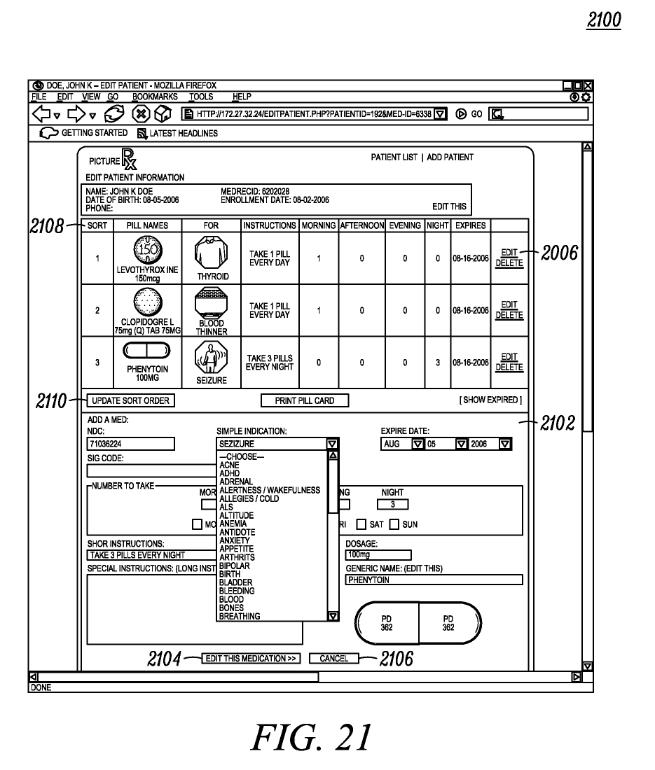

According to another example embodiment, FIG. 21 is an example screen shot 2100 illustrating an example format of a user interface depicting a modification to medication information associated with a patient associated with an example system for generating medication information for patients. To begin, a user may select Edit 2006 next to the medication to be edited. By scrolling to the bottom of the page, the user may view the medication's current information, as shown in FIG. 21. A user may edit any portion of the information, for example, by selecting or clicking on an appropriate field and editing the information. When the user is finished, the user may select Edit this Medication 2104. If the user prefers to exit without saving changes, the user may select Cancel 2106.

In the event that a patient has numerous medications, a user may wish to sort the medications, for example, such that all medications taken at a given time appear together. To adjust the order the order of medications, the user may change a number in a Sort column 2108 and then select Update Sort Order 2110. A user may also change an order of more than one medication at a time, for example, by changing the number of as many medications as desired and then the user may select Update Sort Order 2110.

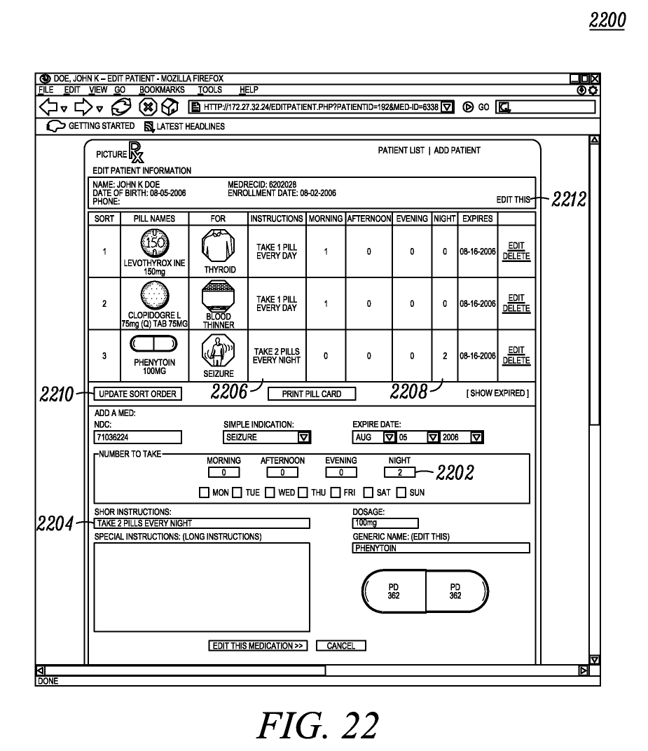

According to another example embodiment, FIG. 22 is an example screen shot 2200 illustrating an example format of a user interface depicting a modification of information associated with a patient associated with an example system for generating medication information for patients. When the user completes editing the medication information, the edited information appears, as shown in FIG. 22. In this case the user has changed Phenytoin from 3 pills at bedtime to 2 (2202, 2204, 2206, 2208).

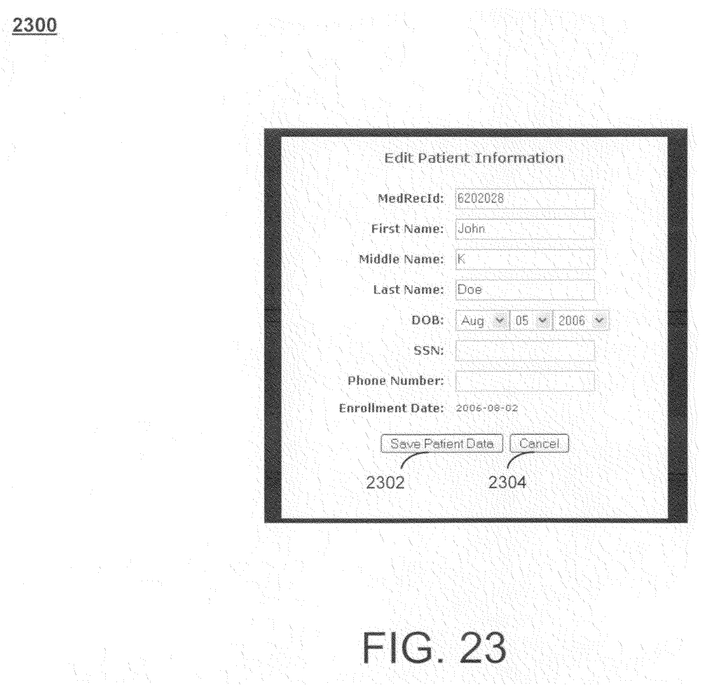

According to another example embodiment, FIG. 23 is an example screen shot 2300 illustrating an example format of a user interface depicting a modification of a information associated with a patient associated with an example system for generating medication information for patients. A user may open up the patient's information as shown in the screen shot 2200 and select edit this 2212 in the area next to the patient's name. The screen shot as shown in FIG. 23 may then be displayed. The user may make any desired changes and select Save Patient Data 2302, or may exit without saving changes by selecting Cancel 2304.

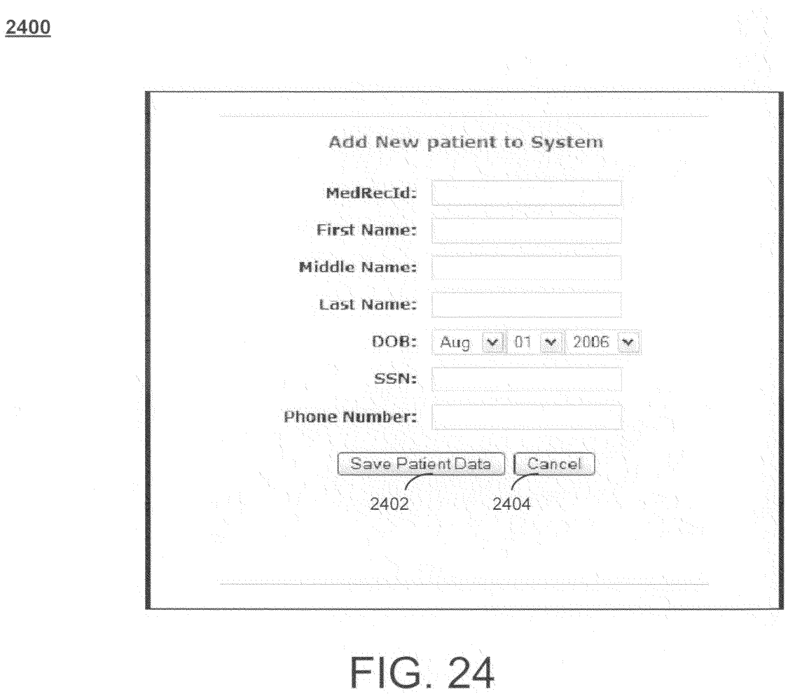

According to another example embodiment, FIG. 24 is an example screen shot 2400 illustrating an example format of a user interface depicting an addition of a patient associated with an example system for generating medication information for patients. To add a patient, a user may choose Add a Patient 1708, 1802, for example, from the top of the screen of one of FIG. 17 or FIG. 18. The user may then view the screen shot 2400. The user may then enter the appropriate information and choose Save Patient Data 2402, or may exit without saving changes by selecting Cancel 2404.

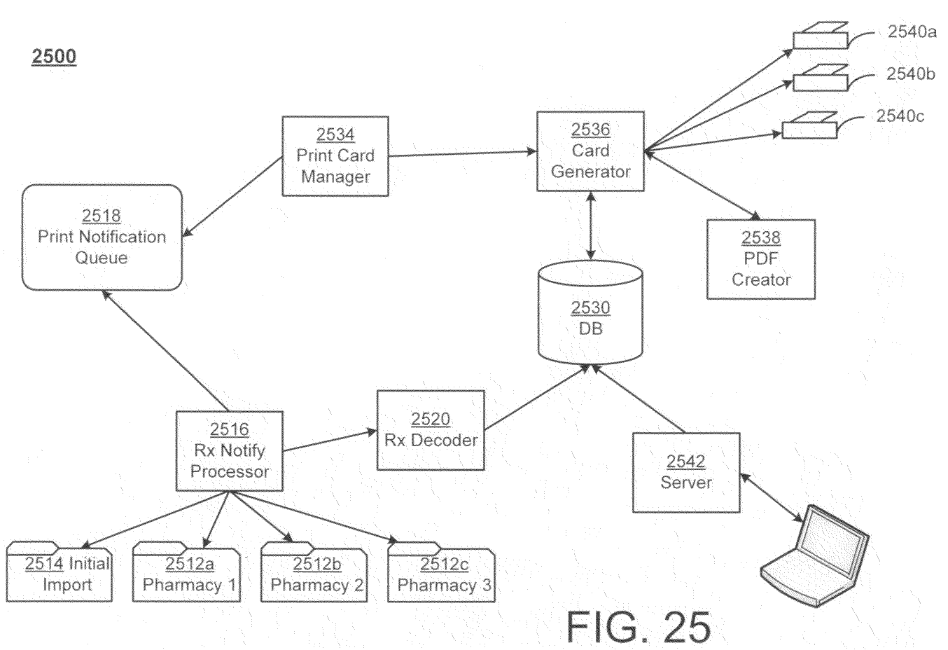

FIG. 25 is an example high level diagram 2500 of an example system for generating medication information for patients. The example system 2500 may include components that correspond to the components described previously with regard to the example system of FIG. 1. For example, the “Rx decoder” 2520 shown in FIG. 25 may correspond to the prescription decoder 120 of FIG. 1. Further, the “server” 2542 shown in FIG. 25 may correspond to the server 142 of FIG. 1. For example, the print notification queue 2518 shown in FIG. 25 may correspond to the print notification queue 118 of FIG. 1. As another example, the card generator 2536 may correspond to the card generator 136 of FIG. 1. As shown in FIG. 25 the system 2500 may be used, for example, to generate and print medication information cards, for example, as prescriptions are filled by a pharmacy, or on demand, for example, by a user interacting with the server. The medication information card may be printed so that the pharmacist or pharmacy technician receives the medication information card at the same time the dispensed medication(s) associated with the prescription is received, and thus there may be no need for the pharmacist to spend time generating the information manually. The pharmacist may, however, manually verify and update the information.

According to an example embodiment, the system of FIG. 1 may further include security provisions, such as requiring passwords or other authentication to access data in the system. The system of FIG. 1 may operate over a computer network to allow multiple operators, multiple points of printing medication information cards or pill cards, and multiple locations for dispensing of the medication and medication information card. The system of FIG. 1 may include a method for manually inputting missing data, such as prescriptions that may have been obtained earlier, or through another pharmacy, or by other means such that the system of FIG. 1 has not automatically detected the particular prescription.

According to an example embodiment, the medication information card may include other example information associated with the patient and medication such as, for example, directions for use and how to take a medication, discretionary information (e.g., avoid sunlight), start date of currently used medications, stop date of discontinued medications, pharmacist's name and contact information, prescriber's name and contact information, and date of creation and most recent update of the information.

An example document may include a jacket, or a pill card, that includes branded information, ranging, for example, from advertising to including the brand name of a drug. This information, for example, may be tied to the medications that a particular patient is taking.

Another example document may include a wallet-sized card that can be punched out of the pill card. As another example, the card may include information regarding all medications associated with the patient. This wallet-sized card may also be printed separately from the card so that it need not be punched out.

Alternatively, the information may be delivered in other ways besides a medication information card. For example, users may be able to log-in and retrieve information, assemble medication information cards, etc. or this information may be sent via a text message.

According to an example embodiment, the medication information card may include information associated with medications, without particular personal patient information. For example, a user may request a medication information card indicating information associated with particular medications or medical supplies, without a prescription, for informational purposes. For example, a family member of a person who is taking a prescription medication may request information regarding the prescription medication in order to be better informed regarding the relative's medical needs. For example, a user may request the medication information card via a web browser online or at a kiosk, without a prescription.

The previous description may thus provide example processes and software for the convenient, automatic creation of medication information cards. An example process for generating the medication information may, for example, include obtaining data on individual prescriptions for individual patients. This data may include data on multiple prescriptions for each patient. The data may include data on multiple patients. The data may be obtained by a number of methods, including, for example, reading text files generated by a patient database engine, or by querying the prescription database directly.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse, trackball, or touchscreen monitor by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

The term “computer-readable medium” as used herein may refer to any medium that participates in providing instructions to a processor for execution. Such a medium may take many forms, including but not limited to non-volatile media, volatile media, and transmission media. Non-volatile media may include, for example, optical or magnetic disks. Volatile media may include dynamic memory. Transmission media may include coaxial cables, copper wire and fiber optics, including wires that may comprise a bus in a computer system. Transmission media can also take the form of acoustic, optical, or electromagnetic waves, such as those generated during radio frequency (RF) and infrared (IR) data communications.

Example forms of computer-readable media may include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the techniques described herein may initially be borne on a magnetic disk of a remote computer. In such a scenario, the remote computer may load the instructions into a main memory and send the instructions over a telephone line using a modem. A modem of a local computer system may receive the data on the telephone line and use an infrared transmitter, for example, to convert the data to an infrared signal and transmit the infrared signal to a portable computing device, such as a personal digital assistant (PDA) or a laptop. An infrared detector on the portable computing device may receive the information and instructions borne by the infrared signal and place the data on a bus. The bus may convey the data to main memory, from which a processor may retrieve and execute the instructions. The instructions received by a main memory can optionally be stored on a storage device either before or after execution by a processor.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the above description.

What is claimed is:

1. A system comprising:
a prescription card manager configured to generate medication information cards, the prescription card manager comprising:
a pharmacy database interface configured to receive notifications associated with medication prescriptions, wherein each one of the notifications includes an identification of a patient, an identification of a medication, and an identification of instructions associated with a specific medication prescription;
a prescription decoder configured to obtain graphical medication representations based on the identification of the medication and to obtain graphical consumption representations based on the identification of instructions associated with the specific medication prescription; and
a card generator configured to generate a representation of a medication information card including one or more of the graphical medication representations and one or more of the graphical consumption representations based on the identification of the patient included in one or more of the notifications.

2. The system of claim 1, comprising:
a patient database configured to store prescription information associated with patients;
a first image database configured to store the graphical medication representations of medications; and
a second image database configured to store the graphical consumption representations of medication consumption instructions, and wherein:
the prescription decoder is configured to
receive the notifications from the pharmacy database interface,
obtain patient identifying information from a prescription database based on the identification of the patient,
determine a frequency of medication consumption based on the instructions associated with a specific medication prescription,
determine a first drug code value based on the identification of the medication,
obtain the graphical medication representation from the first image database based on the identification of the medication,
obtain the graphical consumption representation from the second image database based on the determined frequency of medication consumption, and
store the first drug code value, the graphical medication representation or an indicator associated with the graphical medication representation, and the graphical consumption representation or an indicator associated with the graphical consumption representation associated with the identification of the patient in the patient database, and wherein the card generator is configured to:
receive card requests based on the each one of the notifications from a print manager,
receive the graphical medication representations or indicators associated with the graphical medication representations and the graphical consumption representations or indicators associated with the graphical consumption representations from the patient database based on the card requests, and
generate a representation of a medication information card associated with the identification of the patient and corresponding to the received each one of the card requests.

3. The system of claim 2 wherein the first drug code value includes a National Drug Code (NDC) value.

4. The system of claim 2 wherein the prescription decoder is configured to determine the frequency of medication consumption based on a Sig value included in the instructions associated with the specific medication prescription.

5. The system of claim 2 wherein the medication includes one or more of a medical supply item, a pill, a liquid, a gel, a paste, or an ointment.

6. The system of claim 2 wherein:
the prescription decoder is configured to obtain a graphical purpose representation based on the identification of the medication and to store the graphical purpose representation or an indicator associated with the graphical purpose representation in the patient database, and
the card generator is configured to receive graphical purpose representations from the patient database based on the card requests and to generate the representation of the medication information card associated with the identification of the patient and corresponding to the received each one of the card requests, including the graphical medication representations, the graphical consumption representations, and the graphical purpose representations or indicators associated with the graphical purpose representations received from the patient database based on the card requests.

7. The system of claim 6 wherein one of the graphical medication representations includes a picture of a medication, one of the graphical consumption representations includes a graphical indication of a time of day recommended for using the medication, and one of the graphical purpose representations includes a graphical representation of a purpose for which the medication is prescribed.

8. The system of claim 2 wherein the prescription decoder comprises:
a frequency code translator configured to determine the frequency of medication consumption based on the instructions associated with the specific medication prescription;
a drug code search engine configured to search for the first drug code value associated with the identification of the medication;
an image search engine configured to obtain the one of the graphical medication representations from the first image database based on the identification of the medication, and to obtain the one of the graphical consumption representations from the second image database based on the determined frequency of medication consumption; and
a database interface configured to store the first drug code value, the one of the graphical medication representations or an indicator associated with the one of the graphical medication representations, and the one of the graphical consumption representations or an indicator associated with the one of the graphical consumption representations associated with the identification of the patient in the patient database.

9. The system of claim 2 wherein the pharmacy database interface is configured to generate the card requests including timestamps based on the notifications, the system comprising:
a prescription input storage device configured to store input lists of prescription requests received from one or more pharmacies via a pharmacy manager;
a print notification queue configured to receive the card requests from the pharmacy database interface and to store print notification lists including the received card requests; and
a print manager configured to receive all card requests stored in the print notification queue that are associated with a common identification of a patient and that have been received from the pharmacy database interface by the print notification queue based on the timestamps.

10. The system of claim 1 comprising a document format generator configured to generate a portable document format document including the representation of the medication information card based on a request from the card generator.

11. The system of claim 1 wherein the pharmacy database interface is configured to generate card requests, each one of the card requests including a timestamp based on the each notification, the identification of the patient associated with the notification, and an indicator of a generated card destination, the system comprising:
a print notification queue configured to receive the card requests from the pharmacy database interface and to store print notification lists including the received card requests; and
a print manager configured to receive all card requests stored in the print notification queue that are associated with a common identification of a patient and that have been received from the pharmacy database interface by the print notification queue based on the timestamp values,
wherein the card generator is configured to send the representation of the medication information card associated with the identification of the patient and corresponding to the received each one of the card requests to an output device based on the indicator of the generated card destination.

12. A computer readable medium embodying instructions stored thereon which, when executed by one or more processors, are configured to cause the one or more processors to perform:
receiving a first notification associated with a first medication prescription, wherein the first notification includes an identification of a first patient, an identification of a first medication, and an identification of instructions associated with the first medication prescription;
obtaining a first medication data item from a first database including information associated with the identification of the first medication that includes a first graphical medication representation of the first medication;
obtaining a first graphical consumption representation of consumption instructions associated with the identification of instructions associated with the first medication; and
generating a medication information card including the first graphical medication representation and the first graphical consumption representation based on the identification of the first patient.

13. The computer readable medium of claim 12 wherein the instructions configured to cause the one or more processors to perform generating the medication information card include instructions configured to cause the one or more processors to perform generating the medication information card including the first graphical medication representation, the first graphical consumption representation, and a graphical purpose representation including a graphical representation of a purpose for which the pill is prescribed based on the identification of the first patient.

14. The computer readable medium of claim 12 wherein the instructions are configured to cause the one or more processors to perform determining a National Drug Code (NDC) value associated with the first medication based on the identification of the first medication.

15. The computer readable medium of claim 12 wherein the identification of instructions associated with the first medication prescription include a Sig identification of instructions associated with the first medication prescription.

16. The computer readable medium of claim 12 wherein the instructions are configured to cause the one or more processors to perform:
receiving a second notification associated with a second medication prescription, wherein the second notification includes an identification of the first patient, an identification of a second medication, and an identification of instructions associated with the second medication prescription;
obtaining a second medication data item from the first database including information associated with the identification of the second medication that includes a second graphical medication representation of the second medication; and
obtaining a second graphical consumption representation of consumption instructions associated with the identification of instructions associated with the second medication, wherein
the instructions configured to cause the one or more processors to perform generating the medication information card include instructions configured to cause the one or more processors to perform generating the medication information card including the second graphical medication representation and the second graphical consumption representation based on the identification of the first patient.

17. The computer readable medium of claim 12 wherein the instructions are configured to cause the one or more processors to perform storing an indicator of the first medication prescription and an identifier of the instructions associated with the first medication prescription instructions in a third database based on the identification of the first patient.

18. The computer readable medium of claim 12 wherein the first graphical medication representation of the first medication includes a picture of the first medication, and the first graphical consumption representation of consumption instructions includes a graphical representation of a time of day for consumption of the first medication and a graphical representation of a type of administration of the medication.

19. A method comprising:
receiving a first notification associated with a first medication prescription, wherein the first notification includes an identification of a first patient, an identification of a first medication, and an identification of instructions associated with the first medication prescription;
obtaining a first medication data item from a first database including information associated with the identification of the first medication that includes a first graphical medication representation of the first medication;
obtaining a first graphical consumption representation of consumption instructions associated with the identification of instructions associated with the first medication; and
generating a medication information card including the first graphical medication representation and the first graphical consumption representation based on the identification of the first patient.

20. The method of claim 19 further comprising:
receiving a second notification associated with a second medication prescription, wherein the second notification includes an identification of the first patient, an identification of a second medication, and an identification of instructions associated with the second medication prescription;
obtaining a second medication data item from the first database including information associated with the identification of the second medication that includes a second graphical medication representation of the second medication; and
obtaining a second graphical consumption representation of consumption instructions associated with the identification of instructions associated with the second medication, wherein
generating the medication information card includes generating the medication information card including the second graphical medication representation and the second graphical consumption representation based on the identification of the first patient.

21. The method of claim 20 further comprising:
storing an indicator of the first medication prescription and an identifier of the instructions associated with the first medication prescription instructions in a third database based on the identification of the first patient.

22. The method of claim 20 further comprising:
storing an indicator of the second medication prescription and an identifier of the instructions associated with the second medication prescription instructions in a third database based on the identification of the first patient; and
generating a card jacket based on the identification of the first patient, wherein the card jacket is configured to package the medication information card.

23. A method comprising:
receiving an identification of a patient;
obtaining an identification of a medication and an identification of one or more instructions associated with the medication based on the identification of the patient;
obtaining a medication data item from a first database including information associated with the identification of the medication that includes a graphical medication representation of the medication;
obtaining a graphical consumption representation of consumption instructions associated with the identification of instructions associated with the medication; and
generating a medication information card including the graphical medication representation and the graphical consumption representation based on the identification of the patient.

24. A method comprising:
receiving an identification of a medication and an identification of one or more instructions associated with the medication;
obtaining a medication data item from a first database including information associated with the identification of the medication that includes a graphical medication representation of the medication;
obtaining a graphical consumption representation of consumption instructions associated with the identification of instructions associated with the medication; and
generating a medication information card including the graphical medication representation and the graphical consumption representation based on the identification of the medication and the identification of the instructions.
